(19) United States
(12) Patent Application Publication
(10) Pub. No.: US 2018/0253202 A1
(43) Pub. Date: Sep. 6, 2018

(54) ELECTRONIC DEVICE AND METHOD FOR CONTROLLING APPLICATION THEREOF

(71) Applicant: Samsung Electronics Co., Ltd., Gyeonggi-do (KR)

(72) Inventors: Seung Gyu KONG, Gyeonggi-do (KR); Ho Jun JAYGARL, Gyeonggi-do (KR); Jang Seok SEO, Gyeonggi-do (KR); Kyung Tae KIM, Gyeonggi-do (KR); Jae Yung YEO, Gyeonggi-do (KR); Da Som LEE, Seoul (KR)

(73) Assignee: Samsung Electronics Co., Ltd.

(21) Appl. No.: 15/913,147

(22) Filed: Mar. 6, 2018

(30) Foreign Application Priority Data
Mar. 6, 2017 (KR) 10-2017-0028501

(51) Int. Cl. G06F 3/0484; G06F 3/16; G06F 3/0482; G06F 3/0488; G06F 9/54

(52) U.S. Cl. CPC G06F 3/0484; G06F 3/167; H04W 88/02; G06F 3/04883; G06F 9/54; G06F 3/0482

(57) ABSTRACT

Disclosed is an electronic device including a housing, a touch screen display, a processor, and a memory which stores instructions that, when executed, that cause the processor to execute an application corresponding to a first state to perform the first state, determine whether a second state is executable, based on a first screen of the application, if the second state is executable, determine a virtual user input enabling an execution screen of the application to be changed from the first screen to a second screen corresponding to the second state, display the second screen in the touch screen display based on the virtual user input, and determine whether an execution of the second state is completed, based on the second screen.

### CROSS-REFERENCE TO RELATED APPLICATION(S)

This application is based on and claims priority under 35 U.S.C. § 119 to a Korean Patent Application filed on Mar. 6, 2017 in the Korean Intellectual Property Office and assigned Serial No. 10-2017-0028501, the contents of which are incorporated herein by reference.

### BACKGROUND

### 1. Field of the Disclosure

The present disclosure relates generally to an electronic device, and more particularly, to a technology that controls an application installed in an electronic device based on the utterance of a user.

### 2. Description of Related Art

In addition to a conventional input method using a keyboard or a mouse, electronic devices now support various input schemes such as a voice input. For example, the electronic devices including a smartphone and a tablet personal computer (PC) may recognize the voice of a user input while a speech recognition service is executed and may execute an action or may provide the result based on the voice input.

The speech recognition service is being developed based on a technology processing a natural language. The technology processing the natural language refers to a technology that determines the intent of the user utterance and provides the user with the result suitable for the intent. The electronic device may control an application installed in the electronic device, based on a speech recognition service.

To obtain the result corresponding to the user intent by using a speech recognition service, an electronic device needs to drive a separate service, such as by using the function of another application installed in the electronic device. The speech recognition service may predefine the functions of an application to be used, and may execute a function of the application, which corresponds to a user intent, from among the predefined functions of the application. If the function of an application is not predefined, it is difficult for a speech recognition service to provide the result corresponding to the user intent.

Thus, there is a need in the art for a more user-friendly device and method for providing a speech recognition service.

### SUMMARY

An aspect of the present disclosure is to address at least the above-mentioned problems and/or disadvantages and to provide at least the advantages described below. Accordingly, an aspect is provide to an electronic device and a method that are capable of controlling an application having a known operation function, and an application having an unknown operation function, based on a speech recognition service.

In accordance with an embodiment, an electronic device may include a housing, a touch screen display placed inside the housing and exposed to outside the housing through a first portion of the housing, a microphone placed inside the housing and exposed to the outside of the housing through a second portion of the housing, at least one speaker placed inside the housing and exposed to the outside of the housing through a third portion of the housing, a wireless communication circuit placed inside the housing, a processor placed inside the housing and electrically connected to the touch screen display, the microphone, the speaker, and the wireless communication circuit, and a memory placed inside the housing and electrically connected to the processor, wherein the memory is configured to store a first group of application programs including a first plurality of function calls, and store a second group of application programs downloadable from an application providing platform residing on a first external server, wherein the memory further stores an accessibility framework, which includes a second plurality of function calls and which is a part of an operating system of the electronic device, and wherein the memory stores instructions that, when executed, cause the processor to receive a user request including a request for performing a task using at least one of the first group of application programs and the second group of application programs, through at least one of the touch screen display and the microphone, transmit data associated with the user request to a second external server through the wireless communication circuit, receive a response including first information about a sequence of states for performing the task, and second information about at least one application to be used in association with at least one of the states, from the second external server through the wireless communication circuit, determine whether the at least one application belongs to the first group of application programs or the second group of application programs, if the at least one application belongs to the first group of application programs, identify one of the first plurality of function calls and perform an operation associated with the at least one state using the identified one of the first plurality of function calls, and if the at least one application belongs to the second group of application programs, identify one of the second plurality of function calls and perform the operation associated with the at least one state using the identified one of the second plurality of function calls.

In accordance with another embodiment, an electronic device includes a housing, a touch screen display placed inside the housing and exposed to outside of the housing through a first portion of the housing, a microphone placed inside the housing and exposed to the outside of the housing through a second portion of the housing, a wireless communication circuit placed inside the housing, a processor placed inside the housing and electrically connected to the microphone, the touch screen display, and the wireless communication circuit, and a memory electrically connected to the processor and configured to store one or more applications, wherein the memory stores instructions that, when executed, cause the processor to obtain a user utterance through the microphone, transmit data associated with the user utterance to a server equipped with an intelligence system including a plurality of rules, through the wireless communication circuit, receive a rule, which includes a sequence of states for performing a task corresponding to the user utterance, from among the plurality of rules from the server through the wireless communication circuit, execute an application, which corresponds to a first state, from among the one or more applications to perform the first state of the sequence of states, determine whether a second state subsequent to the first state is executable, based on a first screen of the application displayed in the touch screen display, if the second state is executable, determine a virtual user input enabling an execution screen of the application to be changed from the first screen to a second screen corresponding to the second state, display the second screen after performing the second state in the touch screen display based on the virtual user input; and determine whether an execution of the second state is completed, based on the second screen displayed in the touch screen display.

In accordance with another embodiment, an application controlling method of an electronic device includes obtaining a user utterance, transmitting data associated with the user utterance to a server equipped with an intelligence system including a plurality of rules, receiving a rule, which includes a sequence of states for performing a task corresponding to the user utterance, from among the plurality of rules from the server, executing an application corresponding to a first state to perform the first state of the sequence of states, determining whether a second state subsequent to the first state is executable, based on a first screen of the application, determining, if the second state is executable, a virtual user input enabling an execution screen of the application to be changed from the first screen to a second screen corresponding to the second state, displaying the second screen after performing the second state based on the virtual user input, and determining whether an execution of the second state is completed, based on the second screen.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates an electronic device in a network environment, according to embodiments;

FIG. 2 illustrates a block diagram of the electronic device, according to embodiments;

FIG. 3 illustrates a block diagram of a program module, according to embodiments;

FIGS. 4A, 4B and 4C illustrate integrated intelligent systems, according to an embodiment;

FIG. 5 illustrates a configuration of the electronic device, according to an embodiment;

FIG. 6 illustrates a program module stored in an electronic device, according to an embodiment;

FIG. 7 illustrates a program module stored in an electronic device, according to an embodiment;

FIG. 8 illustrates an application controlling method of an electronic device, according to an embodiment;

FIG. 9 illustrates an application controlling method of an electronic device, according to an embodiment;

FIG. 10 illustrates an application controlling method of an electronic device, according to an embodiment;

FIG. 11 illustrates an application controlling method of an electronic device, according to an embodiment;

FIG. 12 illustrates an application controlling method of an electronic device, according to an embodiment;

FIG. 13 illustrates an application controlling method of an electronic device, according to an embodiment;

FIG. 14 illustrates a screen output by an electronic device, according to an embodiment;

FIG. 15 illustrates an application controlling method of an electronic device, according to an embodiment;

FIG. 16 illustrates a screen output by an electronic device, according to an embodiment;

FIG. 17 illustrates an application controlling method of an electronic device, according to an embodiment; and

FIG. 18 illustrates a screen output by an electronic device, according to an embodiment.

### DETAILED DESCRIPTION

Hereinafter, embodiments may be described with reference to accompanying drawings. Embodiments and terms used herein are not intended to limit the technologies described herein to specific embodiments, and it should be understood that the embodiments and the terms include modifications, equivalents, and/or alternatives to the corresponding embodiments described herein. In description of the drawings, similar elements may be marked by similar reference numerals. In addition, descriptions of well-known functions and constructions may be omitted for the sake of clarity and conciseness.

The terms of a singular form may include plural forms unless otherwise specified. Herein, expressions such as “A or B” and “at least one of A or/and B” used herein may include any and all combinations of one or more of the associated listed items. Expressions such as “first,” or “second,” and the like, may express their elements regardless of their priority or importance and may be used to distinguish one element from another element but are not limited to these components. When a first element is referred to as being operatively or communicatively coupled with/to or connected to a second) element, the first element may be directly coupled with/to or connected to the second element or an intervening element, such as a third element, may be present.

According to the situation, the expression “configured to” used herein may be interchangeably used with the expression “suitable for”, “having the capacity to”, “designed to”, “adapted to”, “made to”, or “capable of”, for example. The expression “a device configured to” may indicate that the device is “capable of” operating together with another device or other components. For example, a “processor configured to (or set to) perform A, B, and C” may refer to an embedded processor for performing a corresponding operation or a generic-purpose processor, such as a central processing unit (CPU) or an application processor (AP), which performs corresponding operations by executing one or more software programs which are stored in a memory device.

According to embodiments, an electronic device may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, medical devices, cameras, or wearable devices such as an accessory including a timepiece, ring, bracelet, anklet, necklace, glasses, contact lens, or head-mounted-device (HMD), one-piece fabric or clothes type of a circuit, such as electronic clothes, a body-attached type of a circuit, such as a skin pad or a tattoo, or a bio-implantable type of a circuit. The electronic device may include at least one of televisions (TVs), digital versatile disc (DVD) players, audios, refrigerators, air conditioners, cleaners, ovens, microwave ovens, washing machines, air cleaners, set-top boxes, home automation control panels, security control panels, media boxes, such as Samsung HomeSync™, Apple TV™, or Google TV™, game consoles, such as Xbox™ or PlayStation™, electronic dictionaries, electronic keys, camcorders, and electronic picture frames.

According to another embodiment, the electronic devices may include at least one of portable medical measurement devices, such as a blood glucose monitoring device, a heartbeat measuring device, a blood pressure measuring device, and a body temperature measuring device, a magnetic resonance angiography (MRA) device, a magnetic resonance imaging (MRI) device, a computed tomography (CT) device, scanners, and ultrasonic devices, navigation and global navigation satellite system (GNSS) devices, event data recorders (EDRs), flight data recorders (FDRs), vehicle infotainment devices, electronic equipment for vessels, such as navigation systems and gyrocompasses, avionics, security devices, head units for vehicles, industrial or home robots, drones, automated teller machines (ATMs), points of sales (POS) devices, or Internet of things (IoT) devices, such as light bulbs, various sensors, sprinkler devices, fire alarms, thermostats, street lamps, toasters, exercise equipment, hot water tanks, heaters, and boilers.

According to another embodiment, the electronic devices may include at least one of parts of furniture, buildings/structures, or vehicles, electronic boards, electronic signature receiving devices, projectors, or various measuring instruments, such as water meters, electricity meters, gas meters, or wave meters, may be a flexible electronic device, and may be a combination of two or more of the above-described devices, but may not be limited to the above-described electronic devices. The term “user” used herein may refer to a person who uses an electronic device or may refer to an artificial intelligence electronic device that uses an electronic device.

According to embodiments, various types of applications may be controlled based on a speech recognition service, by controlling an application in different methods depending on a type of the application.

An application having an unknown operation function may be controlled based on the speech recognition service, by performing an operation corresponding to a user utterance based on a screen displayed in a display to determine the execution result of the operation.

Various applications having an unknown operation function may be controlled through a plug-in corresponding to the application, by selecting the plug-in corresponding to an application to be controlled.

A virtual user input for performing an operation corresponding to a user utterance may be applied to the analyzed screen by analyzing a screen displayed in a display by using an Android framework.

A variety of effects directly or indirectly understood through this disclosure may also be provided.

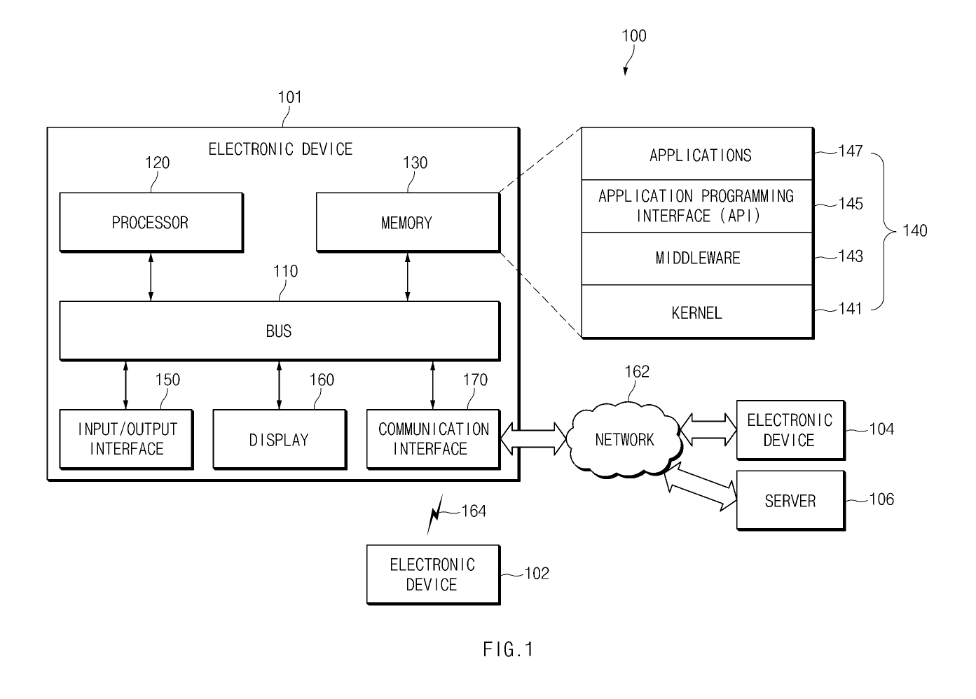

FIG. 1 illustrates an electronic device in a network environment, according to embodiments. Referring to FIG. 1, an electronic device 101 in a network environment 100 1 may include a bus 110, a processor 120, a memory 130, an input/output (I/O) interface 150, a display 160, and a communication interface 170. The electronic device 101 may not include at least one of the above-described elements or may further include other element(s). The bus 110 may interconnect the above-described elements 110 to 170 and may include a circuit for conveying communications, such as a control message or data, among the above-described elements. The processor 120 may include one or more of a CPU, an AP, and a communication processor (CP), and may perform data processing or an operation associated with control or communication of at least one other element(s) of the electronic device 101.

The memory 130 may include a volatile and/or nonvolatile memory, may store instructions or data associated with at least one other element(s) of the electronic device 101, and may store software and/or a program 140 which may include a kernel 141, a middleware 143, an application programming interface (API) 145, and/or application programs (or “applications”) 147. At least a part of the kernel 141, the middleware 143, or the API 145 may be referred to as an operating system (OS). The kernel 141 may control or manage system resources, such as the bus 110, the processor 120, and the memory 130, that are used to execute operations or functions of other programs, such as the middleware 143, the API 145, and the applications 147, and may provide an interface that enables the middleware 143, the API 145, or the applications 147 to access discrete elements of the electronic device 101 so as to control or manage system resources.

The middleware 143 may perform a mediation role such that the API 145 or the applications 147 communicates with the kernel 141 to exchange data, and may process one or more task requests received from the applications 147 according to a priority. For example, the middleware 143 may assign the priority, which enables use of a system resource of the electronic device 101, to at least one of the applications 147 and may process the task requests. The API 145 may be an interface through which at least one of the applications 147 controls a function provided by the kernel 141 or the middleware 143, and may include at least one interface or function for a file control, a window control, image processing, or character control. For example, the I/O interface 150 may transmit an instruction or data, input from a user or another external device, to other element(s) of the electronic device 101, or may output an instruction or data, input from the other element(s) of the electronic device 101, to the user or the external device.

The display 160 may include a liquid crystal display (LCD), a light-emitting diode (LED) display, an organic LED (OLED) display, a microelectromechanical systems (MEMS) display, or an electronic paper display for displaying various types of content to a user, and may include a touch screen and may receive a touch, gesture, proximity, or hovering input using an electronic pen or a portion of a user's body. The communication interface 170 may establish communication between the electronic device 101 and an external electronic device, such as by being connected to a network 162 through wireless communication or wired communication to communicate with an external device.

The wireless communication may include a cellular communication that uses at least one of long-term evolution (LTE), LTE Advanced (LTE-A), code division multiple access (CDMA), wideband CDMA (WCDMA), universal mobile telecommunication system (UMTS), wireless broadband (WiBro), and global system for mobile communications (GSM), for example. The local area network may include at least one of wireless fidelity (Wi-Fi), Bluetooth®, Bluetooth low energy (BLE), Zigbee®, near field communication (NFC), magnetic secure transmission (MST), radio frequency (RF), or body area network (BAN). According to an embodiment, a wireless communication may include, as the GNSS, a global positioning system (GPS), a global navigation satellite system (Glonass), a Beidou navigation satellite system (hereinafter Beidou), or a European global satellite-based navigation system (Galileo). In this specification, “GPS” and “GNSS” may be interchangeably used. The wired communication may include at least one of a universal serial bus (USB), a high definition multimedia interface (HDMI), a recommended standard-232 (RS-232), a power line communication, and a plain old telephone service (POTS). The network 162 may include at least one of a telecommunication network a computer network, such as local area network (LAN) or wide area network (WAN), the Internet, and a telephone network.

Each of the first and second external electronic devices 102 and 104 may be a different type or the same type as the electronic device 101. All or a part of operations that the electronic device 101 will perform may be executed by other electronic devices, such as the electronic devices 102 and 104 and the server 106. According to an embodiment, when the electronic device 101 executes any function or service automatically or in response to a request, the electronic device 101 may not perform the function or the service internally, but, alternatively additionally, may request at least a part of a function associated with the electronic device 701 at another device, which may execute the requested function or an additional function and may transmit the execution result to the electronic device 101, which provides the requested function or service by processing the received result as it is, or additionally. To this end, cloud computing, distributed computing, or client-server computing may be used.

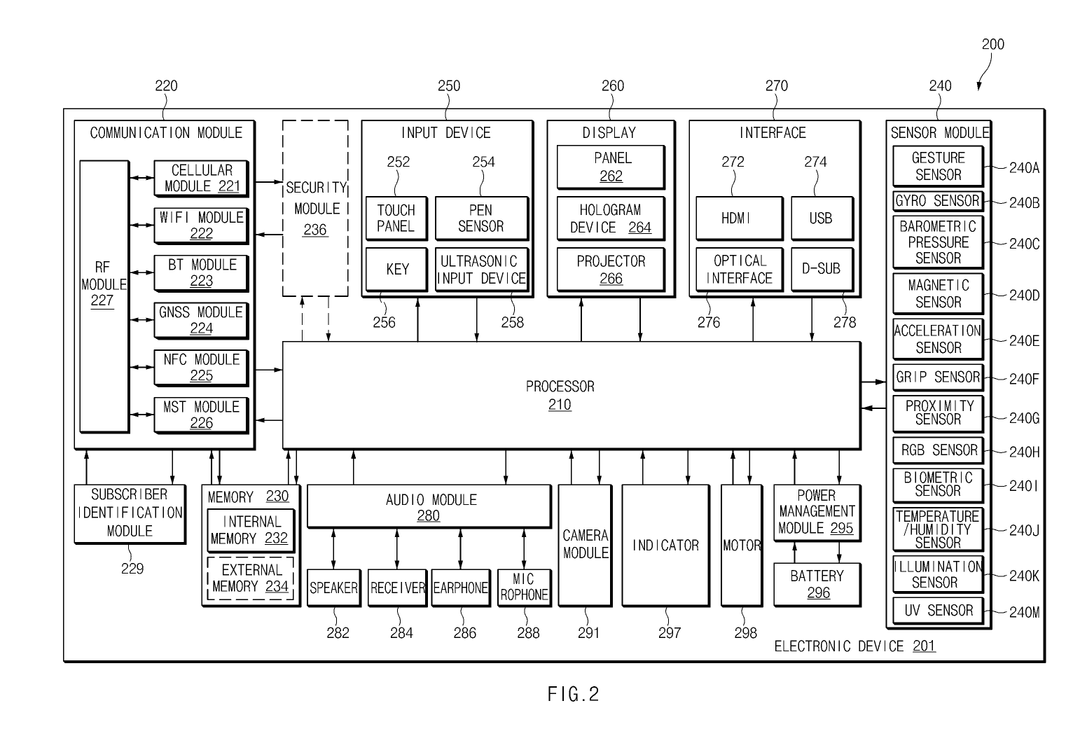

FIG. 2 illustrates an electronic device 201 according to embodiments. The electronic device 201 may include one or more APs 210, a communication module 220, a subscriber identification module (SIM) card 229, a memory 230, a sensor module 240, an input device 250, a display 260, an interface 270, an audio module 280, a camera module 291, a power management module 295, a battery 296, an indicator 297, and a motor 298. The processor 210 may drive an operating system (OS) or an application program to control a plurality of hardware or software elements connected to the processor 210 and may process and compute a variety of data, may be implemented with a system on chip (SoC), may further include a graphic processing unit (GPU) and/or an image signal processor, and may include at least a part of the elements illustrated in FIG. 2. The processor 210 may load and process an instruction or data, which is received from at least one of other elements, such as a nonvolatile memory, and may store result data in a nonvolatile memory.

The communication module 220 may be configured the same as or similar to a communication interface 170. For example, the communication module 220 may include a cellular module 221, a wireless-fidelity (Wi-Fi) module 222, a Bluetooth (BT) module 223, a global navigation satellite system (GNSS) module 224, a near field communication (NFC) module 225, and a radio frequency (RF) module 227. The cellular module 221 may provide voice communication, video communication, a character service, or an Internet service through a communication network, may perform discrimination and authentication of the electronic device 201 within a communication network using the SIM card 229, and may perform at least a portion of functions that the processor 210 provides, and may include a CP. According to an embodiment, at least two of the cellular module 221, the Wi-Fi module 222, the BT module 223, the GNSS module 224, and the NFC module 225 may be included within one integrated circuit (IC) or an IC package. The RF module 227 may transmit and receive an RF signal, and may include a transceiver, a power amplifier module (PAM), a frequency filter, a low noise amplifier (LNA), and an antenna. At least one of the communication modules may transmit and receive an RF signal through a separate RF module. The SIM card 229 may include a card or an embedded SIM which includes a subscriber identification module and may include unique identification information, such as an integrated circuit card identifier (ICCID) or subscriber information, such as an integrated mobile subscriber identity (IMSI).

For example, the memory 230 may include an internal memory 232 or an external memory 234. The internal memory 232 may include at least one of a volatile memory, such as a dynamic random access memory (DRAM), a static RAM (SRAM), and a synchronous DRAM (SDRAM), a nonvolatile memory, such as a one-time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD). The external memory 234 may include a flash drive such as compact flash (CF), secure digital (SD), micro secure digital (micro-SD), mini secure digital (mini-SD), extreme digital (xD), a multimedia card (MMC), and a memory stick, and may be functionally or physically connected with the electronic device 201 through various interfaces.

The sensor module 240 may measure a physical quantity or may detect an operating state of the electronic device 201, may convert the measured or detected information to an electric signal, and may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H, such as a red, green, blue (RGB) sensor, a living body (or biometric) sensor 240I, a temperature/humidity sensor 240J, an illuminance sensor 240K, and an ultraviolet (UV) sensor 240M. The sensor module 240 may further include an e-nose sensor, an electromyography sensor (EMG) sensor, an electroencephalogram (EEG) sensor, an electrocardiogram (ECG) sensor, an infrared (IR) sensor, an iris sensor, and/or a fingerprint sensor, as well as a control circuit that controls at least one or more sensors included therein. The electronic device 201 may further include a processor which is a part of or independent of the processor 210 and is configured to control the sensor module 240 while the processor 210 remains in a sleep state.

The input device 250 may include a touch panel 252, a (digital) pen sensor 254, a key 256, and an ultrasonic input device 258. The touch panel 252 may use at least one of capacitive, resistive, infrared and ultrasonic detecting methods, and may further include a control circuit and a tactile layer to provide a tactile reaction to a user. The (digital) pen sensor 254 may be a part of a touch panel or may include an additional sheet for recognition. The key 256 may include a physical button, an optical key, or a keypad. The ultrasonic input device 258 may detect (or sense) an ultrasonic signal, which is generated from an input device through a microphone 288, and may verify data corresponding to the detected ultrasonic signal.

The display 260 may include a panel 262, a hologram device 264, a projector 266, and/or a control circuit that controls the panel 262, the hologram device 264, and the projector 266. The panel 262 may be implemented to be flexible, transparent or wearable, may be integrated with the touch panel 252 into one or more modules, and may include a pressure sensor (or a force sensor) that is capable of measuring the intensity of pressure on the touch of the user. The pressure sensor may be integrated with the touch panel 252 or with one or more sensors that are independent of the touch panel 252. The hologram device 264 may display a stereoscopic image in a space using a light interference phenomenon. The projector 266 may project light onto a screen so as to display an image. The screen may be arranged inside or outside the electronic device 201. The interface 270 may include a high-definition multimedia interface (HDMI) 272, a universal serial bus (USB) 274, an optical interface 276, or a D-subminiature (D-sub) 278, and may include a mobile high definition link (MHL) interface, a secure digital (SD) card/multi-media card (MMC) interface, or an Infrared Data Association (IrDA) standard interface.

The audio module 280 may convert a sound and an electric signal in dual directions, and may process sound information that is input or output through a speaker 282, a receiver 284, an earphone 286, or the microphone 288. The camera module 291 for shooting a still image or a video may include at least one image sensor, such as a front sensor or a rear sensor, a lens, an image signal processor (ISP), or a flash, such as a light-emitting diode (LED) or a xenon lamp. The power management module 295 may manage power of the electronic device 201 and may include a power management integrated circuit (PMIC), a charger IC, or a battery gauge. The PMIC may have a wired charging method and/or a wireless charging method. The wireless charging method may include a magnetic resonance method, a magnetic induction method, or an electromagnetic method and may further include an additional circuit a coil loop, a resonant circuit, and a rectifier. The battery gauge may measure a remaining capacity of the battery 296 and a voltage, current or temperature thereof while the battery is charged. The battery 296 may include a rechargeable battery and/or a solar battery.

The indicator 297 may display a specific state of the electronic device 201 or a part thereof, such as, such as a booting, message, or charging state. The motor 298 may convert an electrical signal into a mechanical vibration and may generate vibration or haptic effects. For example, the electronic device 201 may include a mobile TV supporting device that processes media data according to the standards of digital multimedia broadcasting (DMB), digital video broadcasting (DVB), and MediaFlo™. Each of the above-mentioned elements of the electronic device according to embodiments may be configured with one or more components, and the names of the elements may be changed according to the type of the electronic device. The electronic device 201 may exclude some elements or may further include other additional elements. Alternatively, some of the elements of the electronic device may be combined with each other so as to form one entity, so that the functions of the elements may be performed in the same manner as prior to the combination.

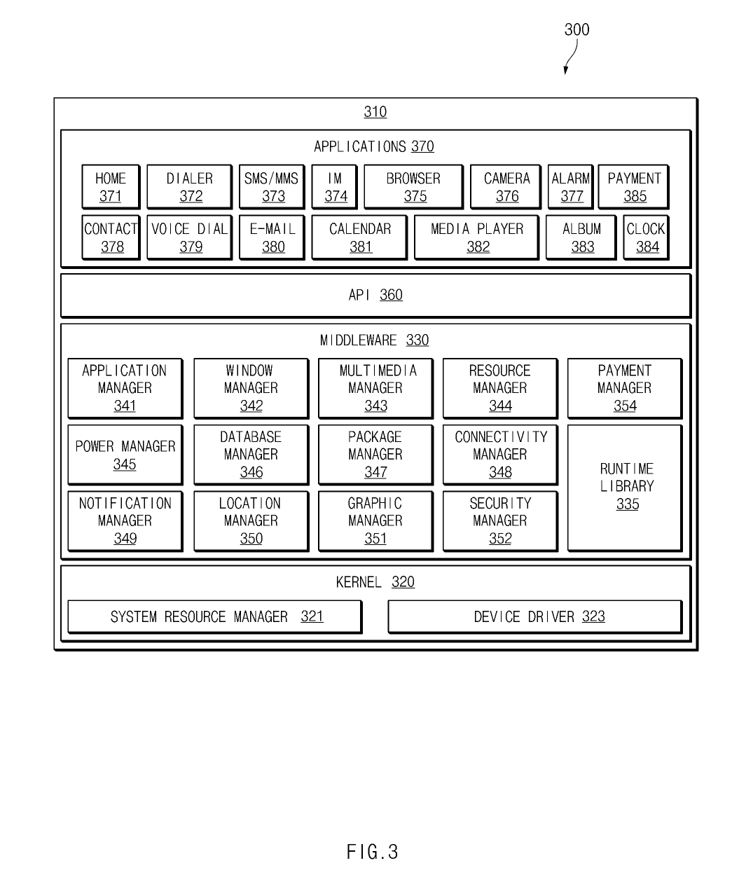

FIG. 3 is a block diagram of a program module, according to embodiments. In FIG. 3, a program module 310 may include an OS to control resources associated with an electronic device and/or diverse applications 370 driven on the OS. The OS may include Android™, iOS™, Windows™, Symbian™, Tizen™, or Bada™. The program module 310 may include a kernel 320, a middleware 330, an API 360, and/or the applications 370. At least a part of the program module 310 may be preloaded on an electronic device or may be downloadable from an external electronic device.

The kernel 320 may include a system resource manager 321 and/or a device driver 323. The system resource manager 321 may perform control, allocation, or retrieval of system resources and may include a process managing unit, a memory managing unit, or a file system managing unit. The device driver 323 may include a display driver, a camera driver, a Bluetooth driver, a common memory driver, a universal serial bus (USB) driver, a keypad driver, a Wi-Fi driver, an audio driver, or an inter-process communication (IPC) driver. The middleware 330 may provide a function which at least one of the applications 370 requires in common or may provide diverse functions to at least one of the applications 370 through the API 360 to enable the applications 370 to use limited system resources of the electronic device. The middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and a payment manager 354.

The runtime library 335 may include a library module, which is used by a compiler, to add a new function through a programming language while at least one of the applications 370 is being executed, and may perform input/output management, memory management, or processing of arithmetic functions. The application manager 341 may manage the life cycle of the applications 370. The window manager 342 may manage a graphic user interface (GUI) resource which is used in a screen. The multimedia manager 343 may identify a format necessary to play media files, and may perform encoding or decoding of media files by using a codec suitable for the format. The resource manager 344 may manage a source code of the applications 370 or a space of a memory. For example, the power manager 345 may manage the capacity of a battery or power, may provide power information that is needed to operate an electronic device, and may operate in conjunction with a basic input/output system (BIOS). For example, the database manager 346 may generate, search for, or use a database which is to be used in the applications 370. The package manager 347 may install or update an application which is distributed in the form of a package file.

The connectivity manager 348 may manage wireless connection. The notification manager 349 may provide a user with an event such as an arrival message, an appointment, or a proximity notification. The location manager 350 may manage location information of an electronic device. The graphic manager 351 may manage a graphic effect to be provided to a user or a user interface relevant thereto. The security manager 352 may provide system security or user authentication. The payment manager 354 may provide payment information related to an application executed by the electronic device.

The middleware 330 may include a telephony manager, which manages a voice or video call function of the electronic device, or a middleware module that combines functions of the above-described elements, may provide a module specialized to each OS type, and may dynamically remove a part of the preexisting elements, or may add new elements thereto. The API 360 may be a set of programming functions and may be provided with another configuration which is variable depending on an OS. For example, when the OS is Android or iOS™, it may be permissible to provide one API set per platform. When an OS is Tizen™, it may be permissible to provide two or more API sets per platform.

The applications 370 may include a home 371, dialer 372, short message service/multimedia messaging service (SMS/MMS) 373, instant message (IM) 374, browser 375, camera 376, alarm 377, contact 378, voice dial 379, e-mail 380, calendar 381, media player 382, album 383, and clock 384 application, a health care application, such as measuring an exercise quantity or blood sugar, and an environment information application, such as for providing atmospheric pressure, humidity, or temperature. The applications 370 may include an information exchanging application that supports information exchange between an electronic device and an external electronic device such as a notification relay application for transmitting specific information to the external electronic device, or a device management application for managing the external electronic device.

For example, the notification relay application may send notification information, which is generated from other applications of an electronic device, to an external electronic device or may receive the notification information from the external electronic device and may provide a user with the notification information. The device management application may install, delete, or update a function, such as turn-on/turn-off of all or part of an external electronic device or adjustment of brightness of a display of the external electronic device, which communicates with an electronic device, or an application running in the external electronic device. The applications 370 may include a health care application of a mobile medical device that is assigned in accordance with an attribute of the external electronic device, and an application received from an external electronic device. At least a part of the program module 310 may be performed by software, firmware, hardware, or a combination of two or more thereof, and may include modules, programs, routines, sets of instructions, or processes for performing one or more functions.

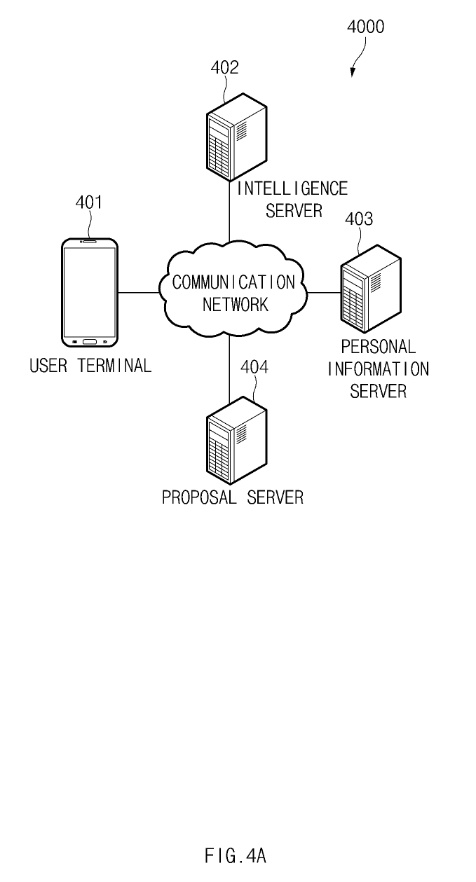

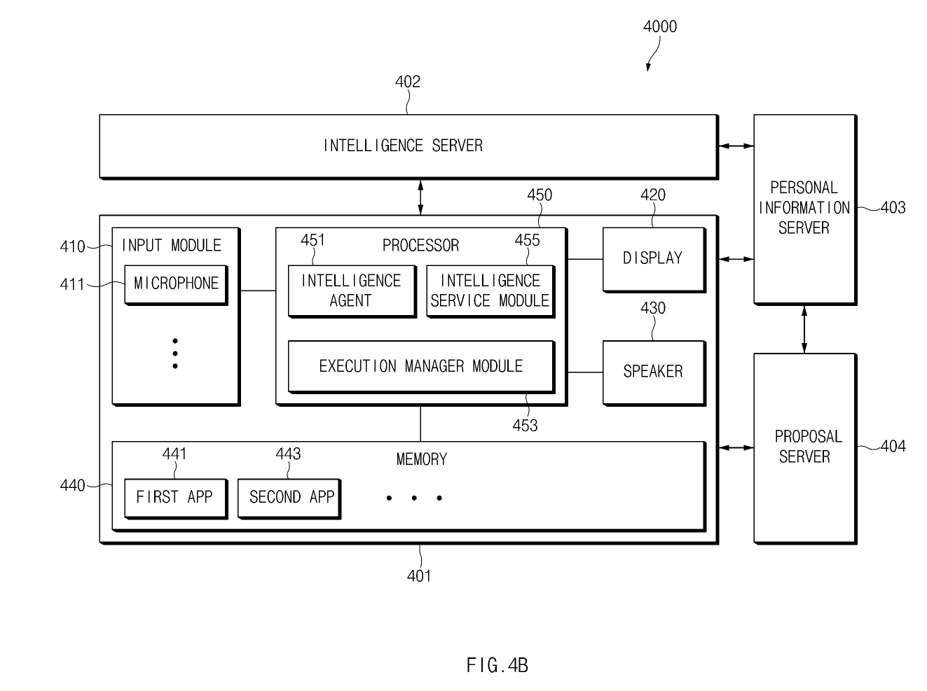

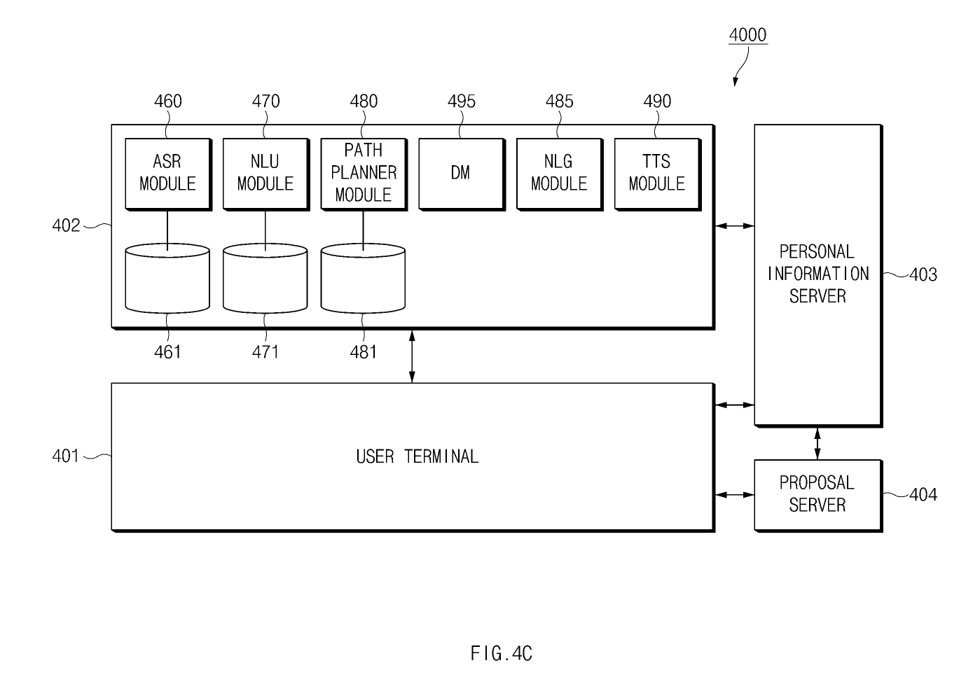

FIGS. 4A, 4B and 4C illustrate integrated intelligent systems, according to an embodiment.

Referring to FIG. 4A, an integrated intelligent system 4000 may include a user terminal 401, an intelligence server 402, a personal information server 403, and a proposal server 404.

The user terminal 401 may provide a user with a service by executing an application stored inside the user terminal 401. For example, the user terminal 401 may execute and control other application(s) by using a speech recognition application stored inside the user terminal 401, and may receive a user input to execute and launch the other application(s), such as through a physical button, a touch pad, or a microphone. The user terminal 401 may be one of various electronic devices, which are able to access Internet, such as a mobile phone, a smartphone, PDA, and a notebook computer, and may include a housing and a display exposed through a part of the housing.

The user terminal 401 may receive the utterance of a user as a user input and may generate an instruction for operating an application based on the utterance of the user, by using the generated instruction.

The intelligence server 402 may receive data associated with the user utterance from the user terminal 401 over a communication network, may convert the data to text data, and may generate or select a rule based on the text data. The rule may include one or more states for performing an operation corresponding to the utterance of the user and information about a parameter necessary to perform the one or more states. When the rule includes a plurality of states, the rule may include information about the sequence of states. The user terminal 401 may receive the rule, may select an application based on the rule, and may perform a state included in the rule by controlling the selected application.

For example, the user terminal 401 may perform a state and may display a screen after performing the state, in a display, or may display the screen after performing an operation based on a touch input or the like, in a display.

The personal information server 403 may include a database in which user information is stored, and may store such user information as context or application execution information, received from the user terminal 401, in the database. When generating a rule corresponding to a user input, the intelligence server 402 may use user information received from the personal information server 403 over the communication network. The user terminal 401 may use the user information, which is received from the personal information server 403 over the communication network, as information for managing the database.

The proposal server 404 may include the database storing information about the function in the user terminal 401, the introduction of an application, or the function to be provided, may receive user information corresponding to the user terminal 401 from the personal information server 403, and may include a database associated with an available function in the user terminal 401 corresponding to the received user information. The user terminal 401 may receive information about the available function from the proposal server 404 over the communication network and may provide a user with the information about the available function.

The integrated intelligent system 4000 may receive a user utterance through the user terminal 401, the intelligence server 402 may generate or select a rule based on the user utterance, and the user terminal 401 may operate an application depending on the rule. The user terminal 401 may include at least part of the functions of the intelligence server 402, the personal information server 403, and the proposal server 404, which may be implemented in one or more external devices. For example, the user terminal 401 may generate or select a rule based on the user input and may operate an application depending on the rule.

Referring to FIG. 4B, an integrated intelligent system 4000 may include the user terminal 401, the intelligence server 402, the personal information server 403, and the proposal server 404. The user terminal 401 may include an input module 410, a display 420, a speaker 430, a memory 440, and a processor 450. The user terminal 401 may further include a housing, and elements of the user terminal 401 may be seated in or positioned on the housing.

The input module 410 may receive a user input from the user, by way of the connected external device, such as a keyboard or a headset, and may include a touch screen display coupled to the display 420, or a hardware (or physical) key placed in the housing of the user terminal 401.

The input module 410 may include a microphone 411 that is capable of receiving the utterance of the user as a voice signal, and may include an utterance input system and may receive the utterance of the user as a voice signal through the utterance input system.

The display 420 may display an image, a video, and/or an execution screen of an application, such as a GUI of an app, and may be a touch screen display to which a touch screen is coupled.

The speaker 430 may output a voice signal generated in the user terminal 401 to the outside.

The memory 440 may store a plurality of apps, such as a first app 441 and a second app 443, which may be selected, executed and driven depending on the user input. For example, the memory 440 may include a nonvolatile memory, such as a flash memory or a hard disk, and a volatile memory, such as a random access memory (RAM), and the plurality of apps 441 and 443 may be stored in the nonvolatile memory, loaded onto the volatile memory and driven.

The memory 440 may include a database capable of storing information necessary to recognize the user input, such as a log database storing log information or a personal database capable of storing user information.

The processor 450 may control overall operations of the user terminal 401, such as controlling the input module 410 to receive the user input, controlling the display 420 to display an image, controlling the speaker 430 to output the voice signal, and controlling the memory 440 to read or store necessary information.

The processor 450 may include an intelligence agent 451, an execution manager module 453, and an intelligence service module 455, which the processor 450 may drive by executing instructions stored in the memory 440. Modules described in embodiments may be implemented by hardware or by software. In embodiments, it is understood that the action executed by the intelligence agent 451, the execution manager module 453, and the intelligence service module 455 is an action executed by the processor 450.

The intelligence agent 451 may generate a command for operating an app based on the voice signal received as the user input. The execution manager module 453 may receive the generated command from the intelligence agent 451, select apps 441 and 443 stored in the memory 440, and execute and drive the selected apps. The intelligence service module 455 may manage information of the user and may use the information of the user to process the user input.

The processor 450 may operate depending on an instruction stored in the memory 440. For example, the instruction stored in the memory 440 may be executed, and then the processor 450 may control the user terminal 401.

Referring to FIG. 4C, the intelligence server 402 may include an automatic speech recognition (ASR) module 460, a natural language understanding (NLU) module 470, a path planner module 480, a natural language generator (NLG) module 485, a text to speech (TTS) module 490, and a distribution manager (DM) 495.

The ASR module 460, the NLU module 470, and the path planner module 480 of the intelligence server 402 may generate a path rule.

The ASR module 460 may change the user input received from the user terminal 401 to text data.

The ASR module 460 may include an utterance recognition module having an acoustic model and a language model. For example, the acoustic model may include information associated with an utterance, and the language model may include unit phoneme information and information about a combination of unit phoneme information. The language model may select a part of the unit phoneme information or may assign weight to a part of the unit phoneme information, based on an ambient context, such as a location or ambient device information, and a usage condition, such as an app state or previous query history. The speech recognition module may convert the utterance of the user to text data by using the information associated with the utterance and unit phoneme information. For example, the information about the acoustic model and the language model may be stored in an automatic voice recognition database 461.

The intelligence server 402 may further include a speaker recognition module that may analyze the utterance of the user based on user information stored in a database to recognize a speaker, may be generated based on the utterance first entered by the user, and may store the generated speaker recognition model in the database. The speaker recognition module may determine whether the user is a speaker registered in the speaker recognition model, based on the speaker recognition model. For example, when the speaker recognition module determines that the user is the registered speaker, the intelligence server 402 may perform all functions corresponding to the user input. When the speaker recognition module determines that the user is an unregistered speaker, the intelligence server 402 may perform only the limited function of the user input. The speaker recognition module may be used as a method (e.g., wakeup recognition) for activating voice recognition, may determine that the registered speaker voice is correct, and may perform voice recognition or natural language processing on the registered speaker voice.

The NLU module 470 may determine user intent by performing syntactic analysis and semantic analysis. The syntactic analysis may divide the user input into syntactic units, such as words, phrases and morphemes, and determine whether the divided units have any syntactic element. For example, the semantic analysis may be performed by using semantic, rule, or formula matching. As such, the NLU module 470 may obtain a domain, intent, and a parameter (or a slot) necessary for the user input to express the intent. The NLU module 470 may store the obtained information in a database 471.

For example, the NLU module 470 may determine the user intent by respectively matching the domain, the intent, and the parameter to cases by using the matching rule included in a rule-based algorithm The path planner module 480 may generate a path rule by using the user intent determined from the NLU module 470. The path planner module 480 may store the generated path rule in a database 481.

The NLG module 485 may change specified information to a text form of a natural language utterance. For example, the specified information may be for additional input and for guiding operation completion. The information changed to the text form may be displayed in the display 120 after being transmitted to the user terminal 401 or may be changed to a voice form after being transmitted to the TTS module 490.

The TTS module 490 may receive the information of the text form from the NLG module 485, may change the information of the text form to the information of a voice form, and may transmit the changed information to the user terminal 401, which may output the information of the voice form to the speaker 130.

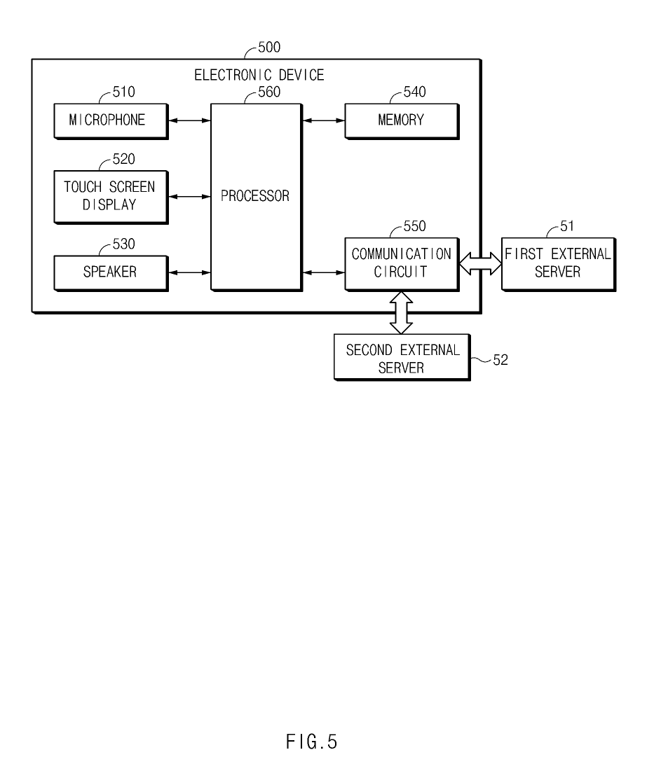

FIG. 5 illustrates a configuration of the electronic device, according to an embodiment.

Referring to FIG. 5, an electronic device 500 may include a housing into which a microphone 510, a touch screen display 520, a speaker 530, a memory 540, a communication circuit 550, and a processor 560 may be placed.

The microphone 510 may be exposed through a first portion of the housing of the electronic device 500, and may sense a sound from the outside, such as a user request or a user utterance.

The touch screen display 520 may be exposed through a second portion of the housing, such as through the front surface of the electronic device 500, may include a display panel and a touch panel, may output an image and may sense a touch input by the user of the electronic device 500.

The speaker 530 may be exposed through a third portion of the housing, may receive an audio signal and may output the received audio signal to the outside.

The memory 540 may store one or more applications, such as a first group of applications and a second group of applications. The first group of applications may include a first plurality of function calls. The function for controlling the first group of applications may be known. For example, when the electronic device 500 is manufactured, the first group of applications may be installed in the electronic device 500. For example, the first group of application programs may include an application, which is installed in the electronic device 500 in advance, such as a gallery, phone, web browser, short message service, contact, and alarm application. The second group of applications may be downloadable from an application providing platform residing on the first external server 51. The second group of application programs may include an application program such as an instant message, social network service (SNS), or a content providing application, which is downloadable from the application providing platform. The function for controlling the second group of applications may not be known. According to an embodiment, a part of applications downloadable from the first external server 51 may be the first group of applications and may include a plurality of function calls. The function for controlling a part of applications downloadable from the first external server 51 may be known.

The memory 540 may store an accessibility framework that is a part of the OS of the electronic device 500. The accessibility framework may include the second plurality of function calls, may recognize an object included in a screen output to the touch screen display 520, and may control the second group of applications by using a function included in the accessibility framework. For example, the accessibility framework may control the second group of applications by applying a virtual user input to the recognized object by using at least part of the second plurality of function calls.

The memory 540 may store a plurality of plug-ins corresponding to the second group of applications, respectively. A plug-in may be used to control the application corresponding to the plug-in.

The communication circuit 550 may communicate with the first external server 51 and a second external server 52. For example, the communication circuit 550 may be a wireless communication circuit capable of communicating in a long term evolution (LTE) or wireless fidelity (Wi-Fi scheme).

The processor 560 may be electrically connected to and control the microphone 510, the touch screen display 520, the speaker 530, the memory 540, and the communication circuit 550.

The processor 560 may receive a user request including a request for performing a task through at least one of the touch screen display 520 or the microphone 510. The task may be performed by at least one of the first group of applications and the second group of applications. For example, the processor 560 may obtain a user utterance through the microphone 510.

The processor 560 may transmit data associated with a user request or a user utterance to the second external server 52 through the communication circuit 550, may convert the user request or the user utterance into data of the form capable of being transmitted, and may transmit the converted data to the second external server 52, which may be a server equipped with an intelligence system including a plurality of rules. In the present disclosure, the rule may refer to the set of one or more states, and may include the sequence of states. The state may correspond to one operation of a plurality of operations for performing the task, and may include one or more parameters for performing an operation. The second external server 52 may include at least part of the intelligence server 402, the personal information server 403, and the proposal server 404, as illustrated in FIG. 4A.

The processor 560 may receive a response from the second external server 52 through the communication circuit 550. For example, the processor 560 may receive a rule, which corresponds to a user utterance, from among a plurality of rules indicating the sequence of states for performing the task, from a server through the communication circuit 550, or may receive a response including first information about the sequence of states for performing the task and second information about at least one application (hereinafter, a “target application”) to be used in association with at least one of the states.

The processor 560 may determine whether the target application belongs to the first group of applications or the second group of applications, based on information included in the rule, which may include information about the name of the target application or an identifier corresponding to the name The processor 560 may determine whether the target application belongs to the first group or the second group, based on information included in the rule and a list of the second group of applications. For example, the memory 540 may store the list of the second group of applications and may update the list. For another example, the memory 540 may store the list of the first group of applications. The processor 560 may determine whether the target application belongs to the first group or the second group, by using the list of the first group of applications or the list of the second group of applications.

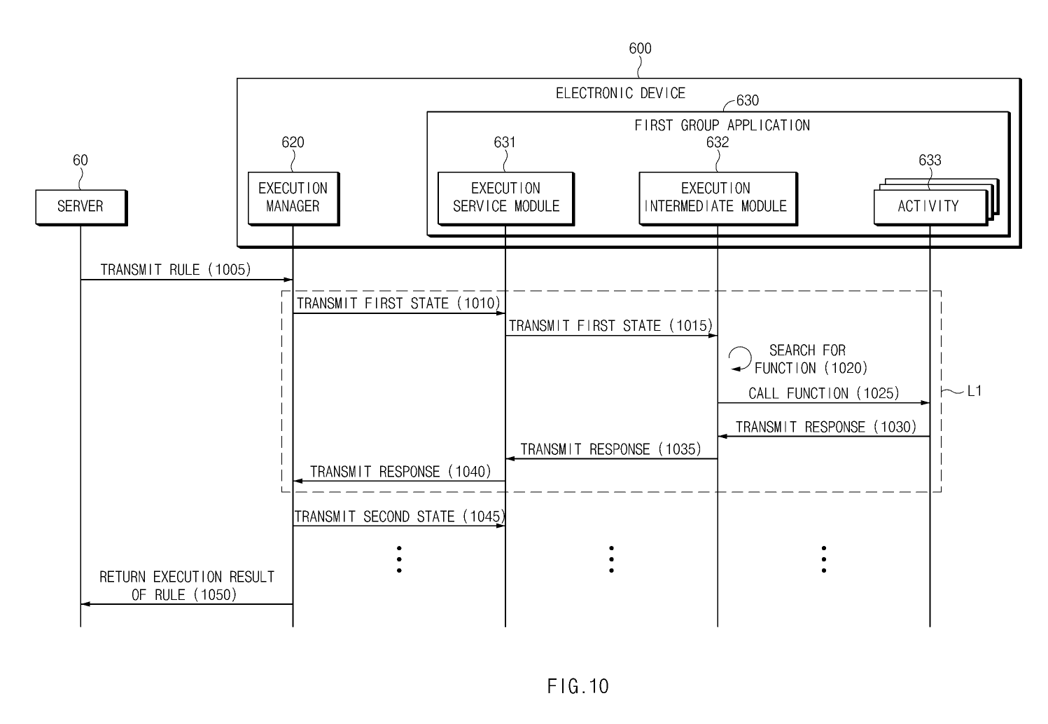

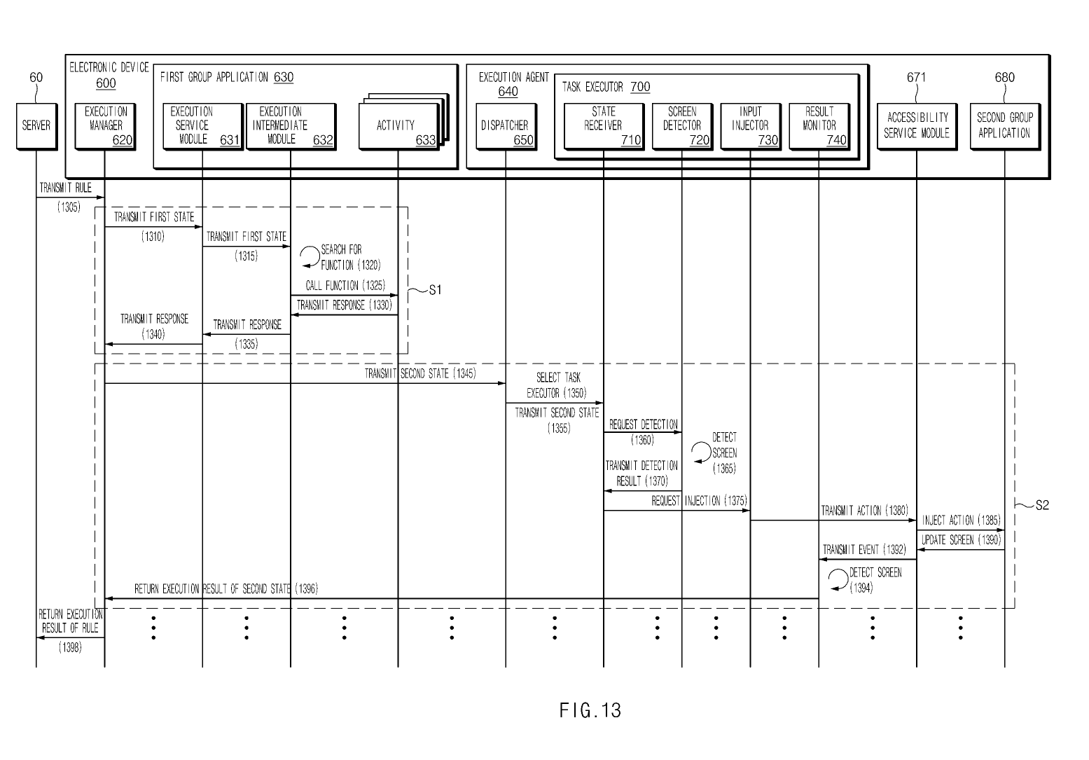

When the target application belongs to the first group of applications, the processor 560 may identify one of the first plurality of function calls and may perform an operation associated with a state, by using one of the identified first plurality of function calls. When the target application belongs to the first group of applications, the electronic device 500 may have knowledge of the function of the target application. The processor 560 may identify a function corresponding to the state, which is to be performed, of the sequence of states, and may perform an operation associated with the state to be performed, by calling the function corresponding to the state to be performed. The detailed process using the function of the target application will be described in detail with reference to FIGS. 10 and 13.

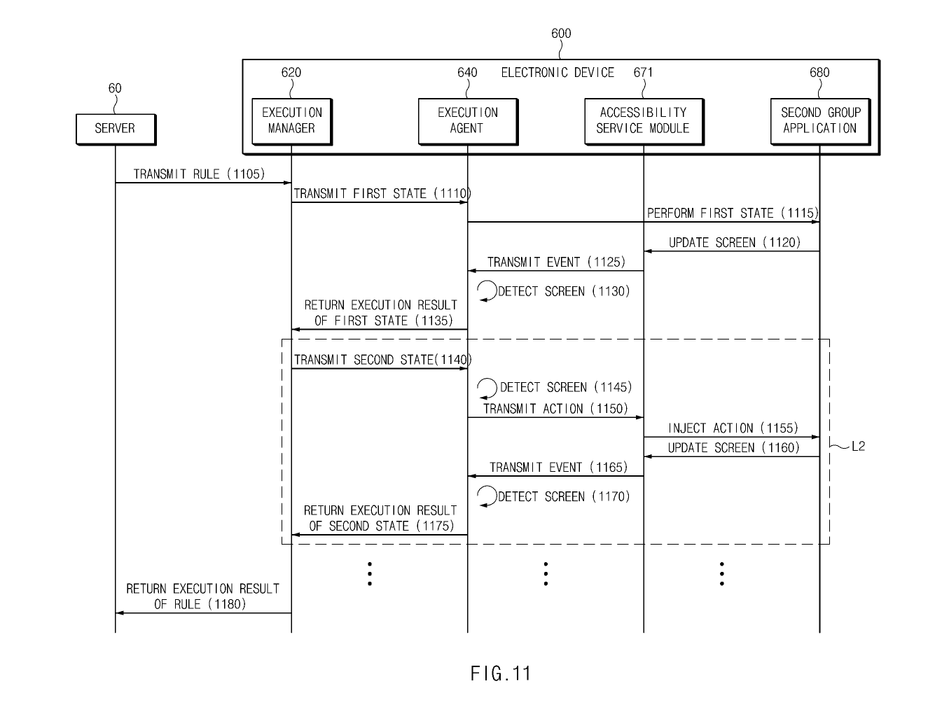

When the target application belongs to the second group of applications, the processor 560 may identify one of the second plurality of function calls and may perform an operation associated with at least one state, by using one of the identified second plurality of function calls. The electronic device 500 may not have knowledge of the function of the target application. The processor 560 may obtain information about an object included in the screen, by using the accessibility framework, may determine an object corresponding to the state, which is to be performed, of the sequence of states and an action associated with the object, such as a UI object of the accessibility framework, may identify the function of the accessibility framework for performing the action determined with respect to the determined object, and may perform an operation associated with the state to be performed, by performing the action determined with respect to the determined object by using the function of the identified accessibility framework. The detailed process using the accessibility framework will be described in detail with reference to FIGS. 11 and 13.

The processor 560 may sequentially perform the sequence of states by using the accessibility framework as follows.

To perform a first state of the sequence of states, the processor 560 may execute an application corresponding to the first state among the second group of applications. The sequence of states may include information about an application for performing the sequence of states. The processor 560 may recognize the target application corresponding to the first state based on the corresponding information and may execute the recognized target application.

The processor 560 may determine whether a second state subsequent to the first state is executable, based on a first screen of the target application displayed in the touch screen display 520, and may analyze the first screen by using the accessibility framework. If the target application is executed, the processor 560 may obtain information about one or more objects included in the first screen, and may determine whether the second state is executable, by comparing information about the first state with information about the one or more objects included in the first screen.

When the second state is executable, the processor 560 may determine a virtual user input that enables the execution screen of the target application to be changed from a first screen to a second screen corresponding to the second state. The processor 560 may determine a virtual user input including information about an object for performing the second state and information about an input method corresponding to the object, based on information about the second state.

The processor 560 may display a second screen after performing the second state based on the virtual user input, in the touch screen display 520 by performing an input on the object, and may perform an operation corresponding to a virtual user input by using the accessibility framework.

The processor 560 may determine whether the execution of the second state is completed, based on the second screen displayed in the touch screen display 520, and may analyze the second screen by using the accessibility framework. If the second screen is displayed in the touch screen display 520, the processor 560 may obtain information about the one or more objects included in the second screen. The processor 560 may determine whether the execution of the second state is completed, by comparing information about the second state with the information about the one or more objects included in the second screen.

If the execution of the second state is completed, the processor 560 may sequentially perform states subsequent to the second state. For example, when the first state, the second state, the third state, and the fourth state are included in the sequence of states, the processor 560 may perform the third state subsequent to the second state in the same manner as that of the second state if the execution of the second state is completed, and may perform the fourth state subsequent to the third state in the same manner as that of the second state if the execution of the third state is completed. The processor 560 may repeat the above-described process until the entire sequence of states is performed.

If the execution of the sequence of states is completed, the processor 560 may transmit the execution result to the second external server 52 through the communication circuit 550. If the execution of all states included in the received rule is completed, the processor 560 may transmit the execution result of a rule to the second external server 52.

The processor 560 may select a plug-in, which corresponds to an application, from among a plurality of plug-ins and may perform the sequence of states by using the plug-in. The processor 560 may select a plug-in, which corresponds to the target application, from among the plurality of plug-ins stored in the memory 540, may execute the target application by using the selected plug-in, may determine a virtual user input, and may display a screen, to which the virtual user input is applied, in the touch screen display 520.

When information associated with a second state of the sequence of states is insufficient, the processor 560 may interrupt the execution of the second state, and then may obtain an additional user utterance associated with the second state through the microphone 510. The processor 560 may transmit data associated with the additional user utterance to a server through the communication circuit 550, and may additionally receive information associated with the second state from the server. When the second state is executable, the processor 560 may determine the virtual user input that enables the execution screen of an application to be changed from the first screen to the second screen, based on the additionally received information associated with the second state.

When the information associated with the second state of the sequence of states is insufficient, the processor 560 may receive a touch input associated with the second state through the touch screen display 520, may display the screen after performing the operation corresponding to the touch input, in the touch screen display 520, and may determine whether the execution of the second state is completed, based on the screen after performing the operation corresponding to the touch input.

The processor 560 may perform the above-described process by executing instructions stored in memory 540.

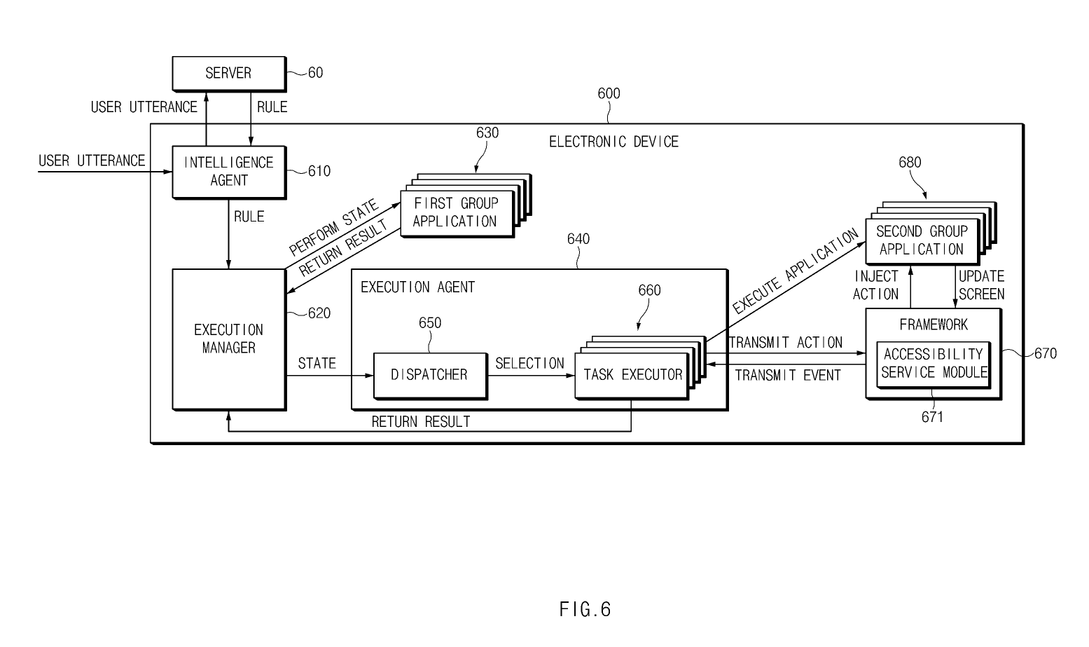

FIG. 6 illustrates a program module stored in an electronic device, according to an embodiment.

Referring to FIG. 6, an electronic device 600 may store an intelligence agent 610, an execution manager 620, a first group application 630, an execution agent 640, a framework 670, and a second group application 680, which may have operations performed by the processor 560 of the electronic device 500.

The intelligence agent 610 may receive a user utterance, may convert the user utterance into a form capable of being transmitted to the server 60, and may transmit data, such as a voice signal, associated with the user utterance to the server 60.

The server 60 may generate or select the rule corresponding to the user utterance, based on the received data. For example, the server 60 may generate or select the rule corresponding to the user utterance, based on a technology such as ASR), NLU, or action planning, and may transmit the generated or selected rule to the intelligence agent 610, which may transmit the received rule to the execution manager 620.

The execution manager 620 may perform the sequence of states included in the rule. For example, when the application corresponding to the rule is the first group application 630 having a known operation function, the execution manager 620 may sequentially perform states included in the rule by sequentially calling functions corresponding to the sequence of states. For example, the execution manager 620 may refer to the execution service of the first group application 630, may match the received rule to the function of the first group application 630, and may perform an operation corresponding to the received rule by calling the matched function.

For example, the first group application 630 may include one or more applications having a known operation function, such as an application installed when the electronic device 600 is manufactured or created by the manufacturer of the electronic device 600. The first group application 630 may sequentially perform the sequence of states, by calling a function corresponding to the state received from the execution manager 620, and may return the execution result of the state to the execution manager 620. FIG. 6 illustrates the electronic device 600 including the four first group application 630. However, embodiments may not be limited thereto. For example, the electronic device 600 may store first group applications having the specified number.

The execution manager 620 may sequentially transmit the sequence of states included in the rule to the execution agent 640. For example, when the application corresponding to the rule is the second group application 680 having an unknown operation function, the execution manager 620 may transmit the sequence of states to the execution agent 640. When a first state, a second state, and a third state are included in the rule, the execution manager 620 may transmit the first state to the execution agent 640, may transmit the second state if the execution of the first state is completed, and may transmit the third state if the execution of the second state is completed.

The execution agent 640 may include a dispatcher 650 and a task executor 660, and may further include a listener for receiving a state from the execution manager 620. The dispatcher 650 may receive the state and may select a task executor, which corresponds to the application that will perform a state, from among the task executors 660 based on the received state. The task executors 660 may correspond to the second group applications 680, respectively. Each of the task executors 660 may be a plug-in program. FIG. 6 illustrates the execution agent 640 including the four task executors 660. However, embodiments may not be limited thereto. For example, the execution agent 640 may include a different number of task executors. A task executor, which is selected by the dispatcher 650, from among the task executors 660 may transmit information about an action corresponding to the state to the framework 670, such as information about an object for performing the state and an input method associated with the object.

For example, the framework 670 may be an Android framework, may include an accessibility service module 671 (or an accessibility framework) that may provide functions such as TTS for reading the content of the screen displayed in the electronic device 600, and a haptic feedback for providing a notification by using vibration, and may be a module provided by the Google® Android framework. The accessibility service module 671 may recognize the attribute or content of the object included in the screen, and may manipulate the recognized object.

For example, the accessibility service module 671 may recognize the object included in the screen by scanning the screen, may recognize an operation executed when an input is applied to the recognized object, and may also recognize an input method, such as a tap, long tap, double tap, scroll, drag, and flicking, for executing the corresponding operation.

The accessibility service module 671 may inject an action into an application corresponding to the selected task executor. For example, the accessibility service module 671 may inject a virtual user input into an object for performing a state, similar to when a user directly applies a touch input to a screen in the input method for performing a state.

FIG. 6 illustrates the electronic device 600 including the four second group application 680. However, embodiments may not be limited thereto. For example, the electronic device 600 may store a different number of second group applications.

If the action is applied to the application corresponding to the selected task executor, the screen displayed in the electronic device 600 may be updated, and the accessibility service module 671 may determine that an event occurs, and then may transmit the event to the selected task executor. The accessibility service module 671 may recognize the attribute or content of the object included in the updated screen, and may transmit the attribute or content of the object to the selected task executor.

If the event is transmitted, the selected task executor may determine whether the execution of a state is completed. If the execution of a state is completed, the selected task executor may return the result to the execution manager 620.

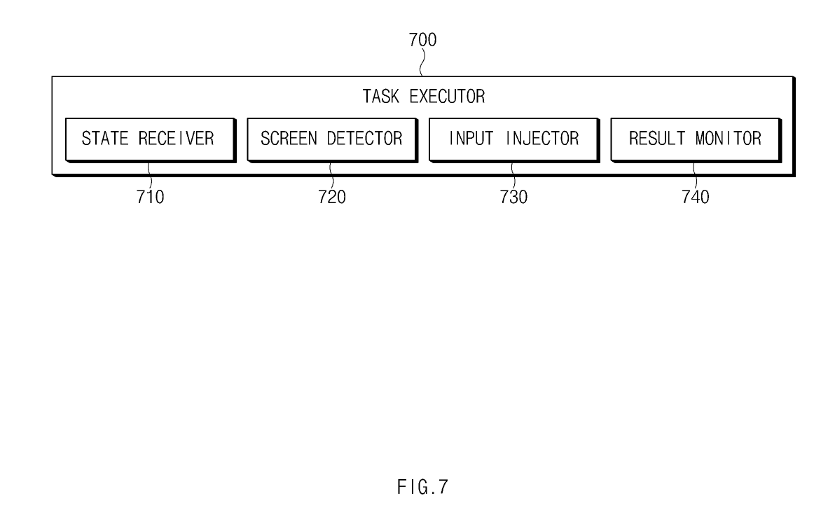

FIG. 7 illustrates a program module stored in an electronic device, according to an embodiment.

Referring to FIG. 7, a task executor 700 may include a state receiver 710, a screen detector 720, an input injector 730, and a result monitor 740.

The state receiver 710 may receive the state included in the rule, from an execution manager through a dispatcher. The dispatcher may select a task executor, which corresponds to an application for performing a state, from among a plurality of task executors, and may transmit the state to the task executor 700, upon which time the state receiver 710 may receive the transmitted state.

The screen detector 720 may detect a screen displayed in the display of an electronic device. Prior to performing the state, the screen detector 720 may detect the screen and may receive information about an object included in the screen, from an accessibility service module. The screen detector 720 may determine whether the corresponding state is executable, based on the information received from the accessibility service module.

The input injector 730 may determine an action corresponding to the state received by the state receiver 710. For example, the input injector 730 may determine an object for performing the state and an input method associated with the object.

The result monitor 740 may detect the screen displayed in the display of the electronic device. After performing the state, the result monitor 740 may detect the updated screen, may receive information about an object included in the updated screen, from the accessibility service module, may determine whether the execution of the state is completed, based on the information received from the accessibility service module, and may return the execution result to the execution manager or a server.

The task executor 700 may correspond to one of applications installed in the electronic device. If the corresponding application is updated, the task executor 700 may also be updated, and may be received from an external device.

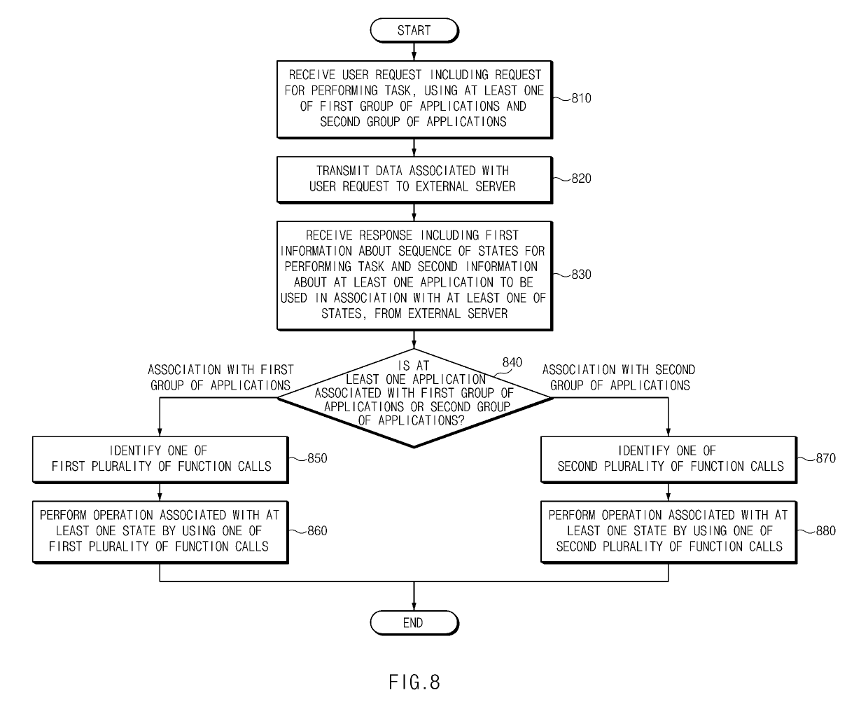

FIG. 8 illustrates an application controlling method of an electronic device, according to an embodiment.

Referring to FIG. 8, in step 810, an electronic device may receive a user request including a request for performing a task, by using at least one of the first group of applications and the second group of applications. For example, an electronic device may receive a user utterance and a touch input that request the execution of a task to transmit a message by using a messenger application.

In step 820, the electronic device may transmit data associated with the user request to an external server. For example, the electronic device may convert the user utterance into data of the form capable of being transmitted to the external server, and may transmit the converted data to the external server.

In step 830, the electronic device may receive, from the external server, a response including first information about the sequence of states for performing the task and second information about at least one application to be used in association with at least one of the states. For example, the external server may convert the received data to text data, and may determine a rule including the sequence of states for performing a task corresponding to the user utterance such as a task to transmit a message by using a messenger application, based on the text data. The electronic device may receive, from the external server, the rule including the sequence of states and information about the messenger application for performing the sequence of states.

In step 840, the electronic device may determine whether at least one application belongs to the first group of applications or the second group of applications, based on information about the messenger application and the list of the second group of applications (or the list of the first group of applications).

When the at least one application belongs to the first group of applications, in step 850, the electronic device may identify one of a first plurality of function calls, such as a function, which corresponds to a state to be performed, from among functions of the messenger application.

In step 860, the electronic device may perform an operation associated with at least one state by using one of the first plurality of function calls, such as by calling the identified function.

When the at least one application belongs to the second group of applications, in step 870, the electronic device may identify one of a second plurality of function calls, such as by analyzing the screen by using an accessibility framework. The electronic device may identify a function, which corresponds to the state to be performed, from among functions of the accessibility framework.

In step 880, the electronic device may perform an operation associated with at least one state by using one of the second plurality of function calls. For example, the processor may apply a virtual user input to at least part of one or more objects included in the screen, by calling the identified function and may perform an operation associated with the state to be performed.

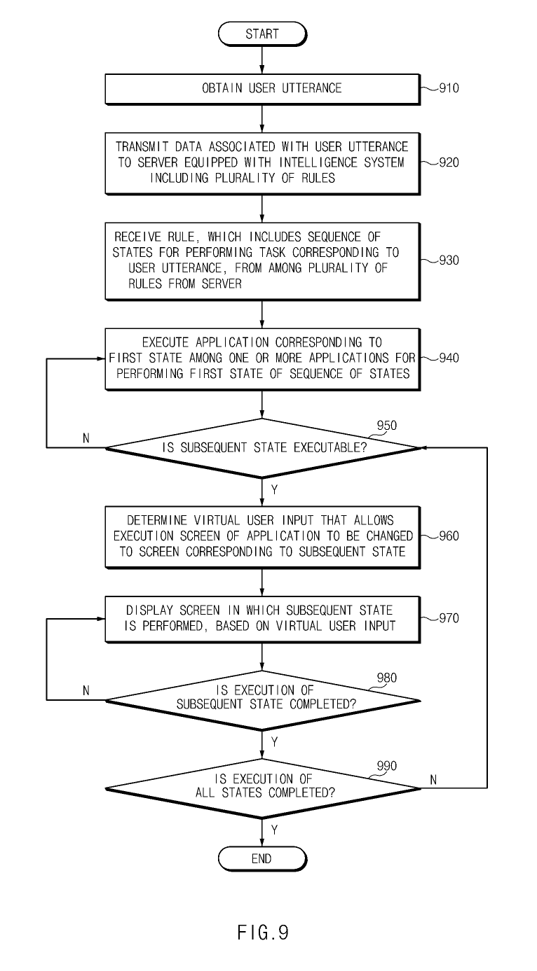

FIG. 9 illustrates an application controlling method of an electronic device, according to an embodiment.

Referring to FIG. 9, in step 910, an electronic device may obtain a user utterance, such as to request the execution of a task to transmit a message by using a messenger application.

In step 920, the electronic device may transmit data associated with the user utterance to a server equipped with an intelligence system including a plurality of rules. For example, the electronic device may convert the user utterance into data of the form capable of being transmitted to the external server, and may transmit the converted data to the external server.

In step 930, the electronic device may receive a rule, which includes the sequence of states for performing a task corresponding to the user utterance, from among a plurality of rules from the server. For example, the external server may convert the received data to text data, and may determine a rule for performing a task corresponding to the user utterance such as a task to transmit a message by using a messenger application, based on the text data. The electronic device may receive a rule including the sequence of states, from the external server.

In step 940, the electronic device may execute an application corresponding to the first state among one or more applications for the purpose of performing a first state of the sequence of states. For example, the first state may correspond to the execution of the messenger application. To perform the first state, the electronic device may perform a messenger application.

In step 950, the electronic device may determine whether the subsequent state is executable. For example, the electronic device may obtain information about an object included in a screen, by analyzing the screen in which the messenger application is executed, and may determine whether the first state is executed normally, by comparing the obtained information about the object with information about the first state. When the first state is normally executed, the electronic device may determine that the second state being the subsequent state is executable.

When the subsequent state is executable, in step 960, the electronic device may determine a virtual user input that enables the execution screen of an application to be changed to a screen corresponding to the subsequent state. For example, the electronic device may determine an object for performing the second state and an input method associated with the corresponding object, based on information about the second state.

In step 970, the electronic device may display a screen after performing the subsequent state, based on the virtual user input, by applying the virtual user input to the screen.

In step 980, the electronic device may determine whether the execution of the subsequent state is completed. For example, the electronic device may obtain information about the object included in the screen, by analyzing the screen after performing the second state, and may determine whether the second state is executed normally, by comparing the obtained information about the object with information about the second state. When the second state is performed normally, the electronic device may determine that the execution of the second state is completed. When the execution of the subsequent state is not completed, step 970 is repeated.

When the execution of the subsequent state is completed, in step 990, the electronic device may determine whether the execution of all the states included in the rule is completed. For example, the electronic device may determine whether the execution of the last state included in the sequence of states is completed. When the execution of all the states is not completed, the electronic device may repeat steps 950 to 980 for the purpose of performing a state subsequent to the performed state. When the execution of all the states is completed, the electronic device may terminate an operation, and then may return the execution result of the rule to a server.

FIG. 10 illustrates an application controlling method of an electronic device, according to an embodiment.

The electronic device 600 may control the first group application 630 by using the execution manager 620, and by calling the function of the first group application 630.

Referring to FIG. 10, in step 1005, the server 60 may transmit the rule to the execution manager 620. For example, the server 60 may receive data associated with a user input, such as a user utterance and/or a touch input, from the electronic device 600, and may select a rule, which corresponds to a user utterance, from among the pre-stored plurality of rules. For another example, the server 60 may generate a rule corresponding to the user utterance. The server 60 may transmit a rule to the intelligence agent of an electronic device, and the execution manager 620 may receive the rule from the intelligence agent.

In step 1010, the execution manager 620 may transmit the first state to an execution service module 631 included in the first group application 630. For example, the execution manager 620 may transmit the first state of the sequence of states included in the received rule, to the execution service module 631, and may determine whether an application performing the first state is the first group application 630 or the second group application. When an application that will perform the first state is the first group application 630, the execution manager 620 may transmit the first state to the execution service module 631.

In step 1015, the execution service module 631 may transmit the first state to an execution intermediate module 632. For example, the execution service module 631 may operate as an interface between the execution manager 620 and the first group application 630.

In step 1020, the execution intermediate module 632 may search for a function for performing the first state. The function corresponding to each state may be stored in advance. FIG. 10 teaches the execution service module 631 as separated from the execution intermediate module 632. However, embodiments may not be limited thereto. For example, the execution service module 631 and the execution intermediate module 632 may be integrated with each other.

In step 1025, the execution intermediate module 632 may call the function, such as by operating an activity 633 for the purpose of performing the first state. In the disclosure the activity may indicate unit operations that are executable in an application.

In step 1030, the activity 633 may transmit a response to the call of the function to the execution intermediate module 632. For example, the activity 633 may transmit the response indicating whether the first state is completed, to the execution intermediate module 632.

In step 1035, the execution intermediate module 632 may transmit the received response to the execution service module 631.

In step 1040, the execution service module 631 may transmit the received response to the execution manager 620, which may receive the response and may verify that the first state is performed.

In step 1045, the execution manager 620 may transmit a second state to the execution service module 631, wherein the second state follows the first state from among the sequence of states to the execution service module 631 and may be performed by an application different from the application performing the first state. In this case, the execution manager 620 may transmit the second state to an application different from the application performing the first state.

The electronic device 600 may repeat operations L1 for performing the first state with respect to the remaining states included in the sequence of states, and may sequentially perform all the states included in sequence of states, by repeating operations L1 with respect to the remaining states.

If all the states included in the sequence of states are performed, in step 1050, the execution manager 620 may return the execution result of the rule to the server 60, which may verify that the execution of the rule is completed.

FIG. 11 illustrates an application controlling method of an electronic device, according to an embodiment.

The electronic device 600 may control the second group application 680 by using the execution agent 640 and the accessibility service module 671. For example, the electronic device 600 may analyze a screen displayed in the electronic device 600 and may inject an action corresponding to a state into the screen to control the second group application 680.

Referring to FIG. 11, in step 1105, the server 60 may transmit the rule, which is matched to a user input, such as user utterance and/or touch input, to the execution manager 620. The rule may include the sequence of states.

In step 1110, the execution manager 620 may transmit a first state to the execution agent 640. For example, the execution manager 620 may analyze the rule from the server 60, and may obtain the sequence of states included in the rule. The rule may include a field associated with the name of an application for performing the rule or the name of a task executor controlling the application. For example, the first state may correspond to the execution of an application for performing the rule. The execution manager 620 may determine whether the application that will perform the first state is a first group application or the second group application 680. When an application that will perform the first state is the second group application 680, the execution manager 620 may transmit the first state to the execution agent 640.

In step 1115, the execution agent 640 may perform the first state. For example, the execution agent 640 may execute the second group application 680 for performing the rule. If the second group application 680 is executed, the electronic device 600 may output the execution screen of the second group application 680.

In step 1120, the accessibility service module 671 may update the screen. For example, if the second group application 680 is executed, the screen output to the electronic device 600 may be changed, as recognized by the accessibility service module 671.

In step 1125, the accessibility service module 671 may transmit an event to the execution agent 640. For example, if the screen is changed, the accessibility service module 671 may determine that the event occurs, and may notify the execution agent 640 that the event occurs.

In step 1130, the execution agent 640 may detect a screen displayed in the electronic device 600. For example, the accessibility service module 671 may obtain information about an object included in the screen, by analyzing the screen. The execution agent 640 may determine whether the first state is completed, by comparing information about an object included in the current screen with information about the first state. When the first state is completed, the information about the first state may include information about an object that needs to be included in the screen.

If it is determined that the first state is completed in step 1130, in step 1135, the execution agent 640 may return the execution result of the first state to the execution manager 620. For example, the execution agent 640 may return the result indicating whether the first state is completed, to the execution manager 620. Unlike the case of the first group application, the execution agent 640 may return the result after determining whether the first state is completed in step 1130.

When the execution of the first state is completed, in step 1140, the execution manager 620 may transmit a second state subsequent to the first state, to the execution agent 640.

In step 1145, the execution agent 640 may detect a screen displayed in the electronic device 600. For example, the execution agent 640 may determine whether the second state is capable of being performed, by comparing information about an object included in the current screen with information about the first state.

In step 1150, the execution agent 640 may transmit the action for performing the second state, to the accessibility service module 671. The action may include the object for performing the second state and an input method associated with the object.

In step 1155, the accessibility service module 671 may inject the action into the second group application 680. For example, the accessibility service module 671 may apply a virtual user input to the object for performing the second state, in the input method performing the second state Similar to when the user of the electronic device 600 applies a touch input to the object in the input method, the accessibility service module 671 may inject the action, and thus may perform the second state.

In step 1160, the accessibility service module 671 may update the screen. For example, if the second state is performed, the execution screen of the second group application 680 output to the electronic device 600 may be changed, as recognized by the accessibility service module 671.

In step 1165, the accessibility service module 671 may transmit an event to the execution agent 640. For example, if the screen is changed, the accessibility service module 671 may determine that the event occurs, and may notify the execution agent 640 that the event occurs.

In step 1170, the execution agent 640 may detect a screen displayed in the electronic device 600. For example, the execution agent 640 may determine whether the second state is completed, by comparing information about an object included in the current screen with information about the second state. When the second state is completed, the information about the second state may include information about an object that needs to be included in the screen.

In step 1175, the execution agent 640 may return the execution result indicating whether the second state is completed, to the execution manager 620.

The electronic device 600 may repeat operations L2 for performing the second state with respect to the remaining states included in the sequence of states. The electronic device 600 may sequentially perform all the states included in sequence of states, by repeating operations L2 with respect to the remaining states.

If all the states included in the sequence of states are performed, in step 1180, the execution manager 620 may return the execution result of the rule to the server 60, which may verify that the execution of the rule is normally completed.

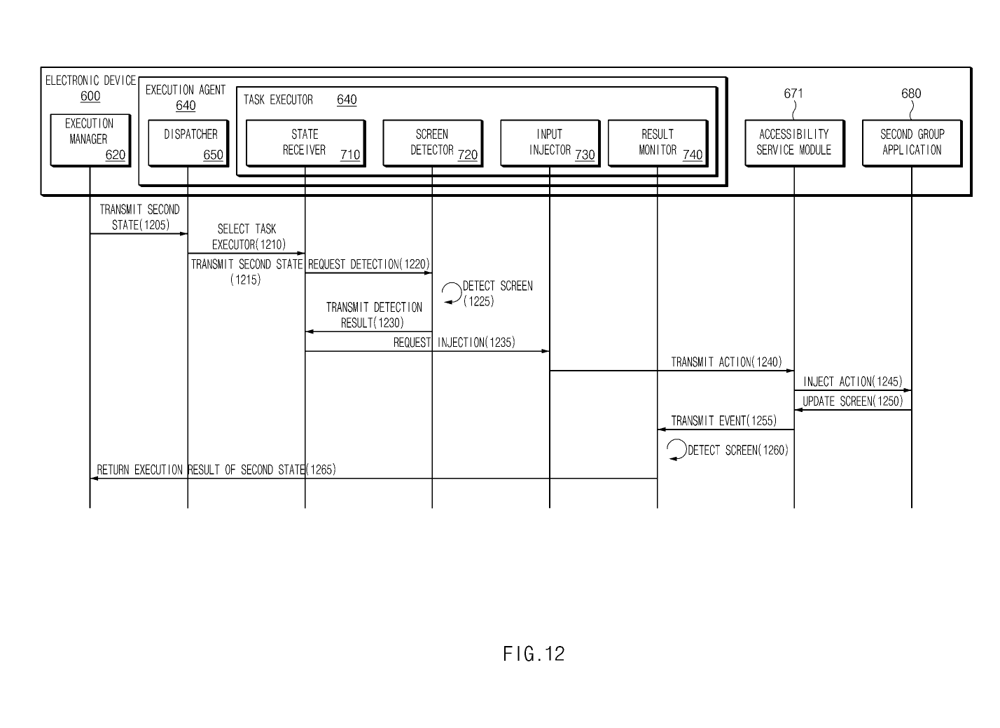

FIG. 12 illustrates an application controlling method of an electronic device, according to an embodiment. Hereinafter, steps included in L2 of FIG. 11 will be described in detail with reference to FIG. 12. For convenience of description, a description previously described with reference to FIG. 11 will not be repeated here.

An electronic device may select a task executor corresponding to a second group application for performing the received rule, by using a dispatcher and may control the second group application by using the selected task executor.

Referring to FIG. 12, in step 1205, the execution manager 620 may transmit the second state to the dispatcher 650.

In step 1210, the dispatcher 650 may select the task executor 700 corresponding to the second group application 680 for performing the second state, based on information included in the rule or the second state. For example, the task executor 700 may be one application downloadable from an application providing platform.

In step 1215, the dispatcher 650 may transmit the second state to the state receiver 710 of the task executor 700 for controlling the second group application 680.

In step 1220, the state receiver 710 may make a request for the detection of a screen to the screen detector 720, in response to the reception of the second state.

In step 1225, the screen detector 720 may detect a screen displayed in the electronic device 600. For example, the screen detector 720 may determine whether the current screen is in a state where the second state is capable of being performed, by comparing information about an object included in the current screen with information about the second state.

In step 1230, the screen detector 720 may transmit the detection result to the state receiver 710, such as by notifying the state receiver 710 that the second state is capable of being performed.

When the current screen is in a state where the second state is capable of being performed, in step 1235, the state receiver 710 may request the input injector 730 to inject an input. For example, the state receiver 710 may request the input injector 730 to perform the second state.

In step 1240, the input injector 730 may transmit an action to the accessibility service module 671. For example, the input injector 730 may determine an action including information about an object for performing the second state and an input method, and may transmit the information about the object and the input method, to the accessibility service module 671.

In step 1245, the accessibility service module 671 may inject the action into the second group application 680.

In step 1250, the accessibility service module 671 may update the screen.

In step 1255, the accessibility service module 671 may transmit an event to the result monitor 740 of the task executor 700.

In step 1260, the result monitor 740 may detect a screen displayed in the electronic device 600. For example, the result monitor 740 may determine whether the second state is completed, by comparing information about an object included in the current screen with information about the second state.

In step 1265, the result monitor 740 may return the execution result of the second state to the execution manager 620.

The electronic device 600 may repeat steps 1205 to 1265 with respect to states subsequent to the second state.

FIG. 13 illustrates an application controlling method of an electronic device, according to an embodiment. For descriptive convenience, a description of the method given with reference to FIGS. 10 to 12 will not be repeated here.

When an application for performing a first state is the first group application 630, and when an application for performing a second state is the second group application 680, the electronic device 600 may perform the first state by using the execution manager 620 and may perform the second state by using the execution agent 640 and the accessibility service module 671.

Referring to FIG. 13, in step 1305, the server 60 may transmit the rule to the execution manager 620.

In step 1310, the execution manager 620 may transmit the first state to the execution service module 631 of the first group application 630. For example, the execution manager 620 may determine whether an application for performing the first state is the first group application 630 or the second group application 680. When the application for performing the first state is the first group application 630, the execution manager 620 may transmit the first state to the first group application 630 for the purpose of performing the first state, by calling the function of the first group application 630.

In step 1315, the execution service module 631 may transmit the first state to the execution intermediate module 632.

In step 1320, the execution intermediate module 632 may search for a function.

In step 1325, the execution intermediate module 632 may call the function.

In step 1330, the activity 633 may transmit a response to the call of the function to the execution intermediate module 632.

In step 1335, the execution intermediate module 632 may transmit the received response to the execution service module 631.

In step 1340, the execution service module 631 may transmit the received response to the execution manager 620.

In step 1345, the execution manager 620 may transmit the second state to the dispatcher 650 of the execution agent 640. For example, the execution manager 620 may determine whether an application for performing the second state is the first group application 630 or the second group application 680. When the application for performing the second state is the second group application 680, the execution manager 620 may transmit the second state to the dispatcher 650 for the purpose of performing the second state by using the execution agent 640 and the accessibility service module 671.

When the second state is the execution of the second group application 680, the execution agent 640 may perform the second state as illustrated in steps 1115 to 1135 of FIG. 11. When the second group application is executed in advance, the execution agent 640 may perform the second state as described below.

In step 1350, the dispatcher 650 may select the task executor 700.

In step 1355, the dispatcher 650 may transmit the second state to the state receiver 710 of the task executor 700.

In step 1360, the state receiver 710 may make a request for the detection of a screen to the screen detector 720.

In step 1365, the screen detector 720 may detect a screen displayed in the electronic device 600.

In step 1370, the screen detector 720 may transmit the detection result to the state receiver 710.

When the current screen is in a state where the second state is capable of being performed, in step 1375, the state receiver 710 may request the input injector 730 to inject an input.

In step 1380, the input injector 730 may transmit an action to the accessibility service module 671.

In step 1385, the accessibility service module 671 may inject the action into the second group application 680.

In step 1390, the accessibility service module 671 may update the screen.

In step 1392, the accessibility service module 671 may transmit an event to the result monitor 740 of the task executor 700.

In step 1394, the result monitor 740 may detect a screen displayed in the electronic device 600.

In step 1396, the result monitor 740 may return the execution result of the second state to the execution manager 620.

The electronic device 600 may repeat steps S1 including steps 1310 to 1340 with respect to a state, which is associated with the first group application 630, from among states subsequent to the second state, and may repeat steps S2 including steps 1345 to 1396 with respect to the state associated with the second group application 680.

If all the states included in the sequence of states are performed, in step 1398, the execution manager 620 may return the execution result of the rule to the server 60.

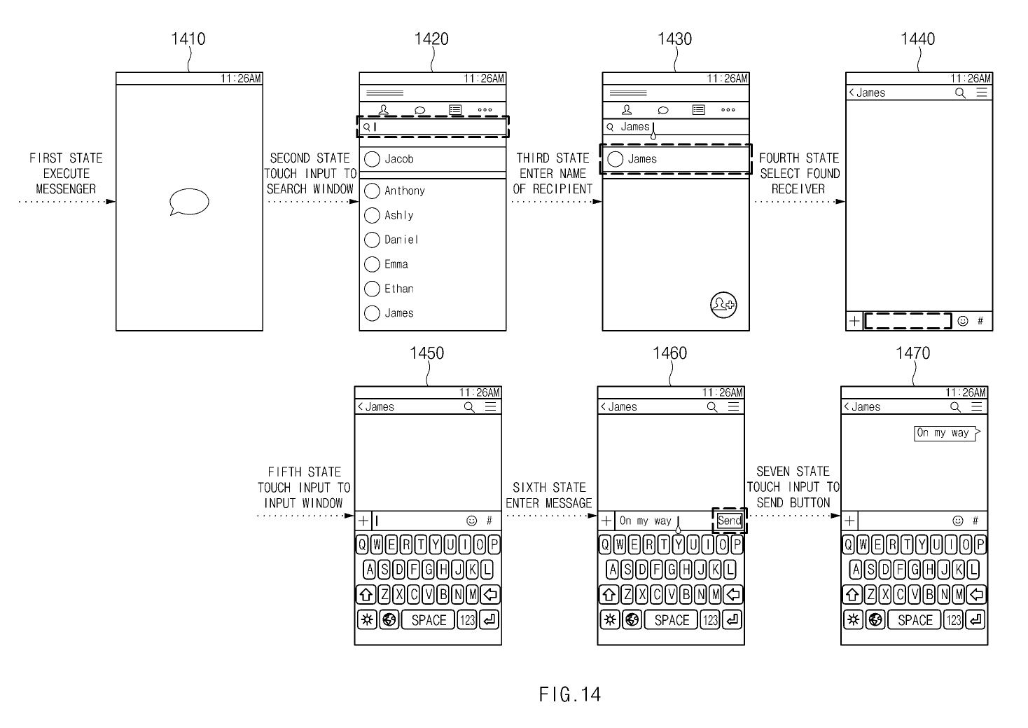

FIG. 14 illustrates a screen output by an electronic device, according to an embodiment.

Referring to FIG. 14, an electronic device may receive a rule from a server, which may receive data associated with a user utterance saying that “send a message by using a messenger to James saying that I'm on my way”, select or generate the rule corresponding to the user utterance, and transmit the rule to the electronic device which may sequentially perform the sequence of states included in the rule. The sequence of states may include seven states, i.e., executing a messenger, a touch input to a search window, entering the name of a recipient, selecting the found receiver, a touch input to an input window, entering a message, and a touch input to a send button.

The electronic device may perform the first state, such as an execution of a messenger, and may execute the messenger and output a first screen 1410.

If the execution of the first state is completed, the electronic device may perform a second state, such as a touch input to a search window. The electronic device may apply a virtual touch input to the search window. If the second state is performed, the electronic device may output a second screen 1420. The electronic device may determine whether the second state is completed, by analyzing the second screen 1420. Hereinafter, the electronic device may determine whether each of a third state, a fourth state, a fifth state, a sixth state, and a seventh state is completed, by analyzing each of these screens.

If the execution of the second state is completed, the electronic device may perform the third state, such as an input of the name of a recipient. The electronic device may apply the virtual touch input for entering the name of the recipient. If the third state is performed, the electronic device may output the third screen 1430.

If the execution of the third state is completed, the electronic device may perform the fourth state, such as by selecting the found recipient. The electronic device may apply the virtual touch input to an object corresponding to the found recipient. If the fourth state is performed, the electronic device may output the fourth screen 1440.

If the execution of the fourth state is completed, the electronic device may perform the fifth state, such as a touch input to an input window. The electronic device may apply a virtual touch input to the input window. If the fifth state is performed, the electronic device may output the fifth screen 1450.

If the execution of the fifth state is completed, the electronic device may perform the sixth state, such as an input of a message. An electronic device may apply a virtual touch input for entering a message saying that “on my way” to a soft keyboard. If the sixth state is performed, the electronic device may output the sixth screen 1460.

If the execution of the sixth state is completed, the electronic device may perform the seventh state, such as a touch input to a send button. The electronic device may apply the virtual touch input to the send button. If the seventh state is performed, the electronic device may output the seventh screen 1470.

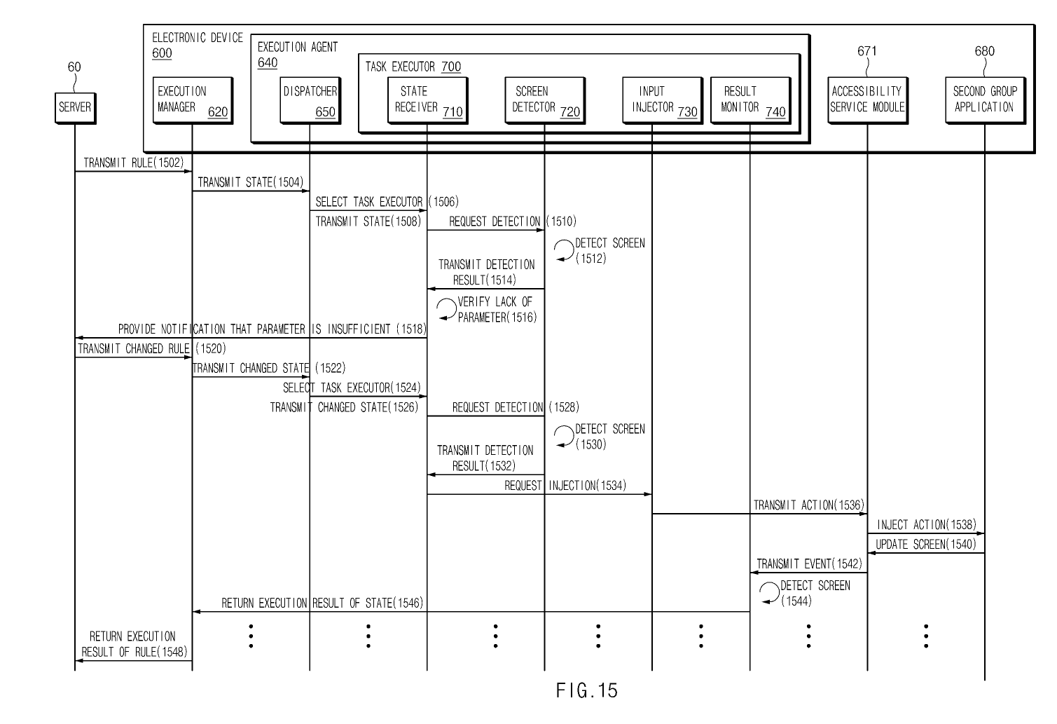

FIG. 15 illustrates an application controlling method of an electronic device, according to an embodiment.

According to an embodiment, when information associated with a state to be performed is insufficient, the electronic device 600 may interrupt the execution of the state and then may obtain an additional utterance or an additional touch input from a user.

Referring to FIG. 15, in step 1502, the server 60 may transmit a rule to the execution manager 620 of the electronic device 600. In step 1504, the execution manager 620 may transmit the state to the dispatcher 650 of the execution agent 640. In step 1506, the dispatcher 650 may select the task executor 700. In step 1508, the dispatcher 650 may transmit the state to the state receiver 710 of the task executor 700. In step 1510, the state receiver 710 may make a request for the detection of a screen to the screen detector 720. In step 1512, the screen detector 720 may detect a screen displayed in the electronic device 600. In step 1514, the screen detector 720 may transmit the detection result to the state receiver 710.

In step 1516, the state receiver 710 may verify the lack of a parameter. For example, the state may correspond to an operation of searching for a recipient, and a user utterance may not include information about the recipient. In this case, the parameter, such as recipient information, for performing the state may be insufficient. The electronic device 600 may interrupt the execution of the state, output a notification, such as a popup message, a vibration notification, or a sound notification, for providing a notification that the parameter is insufficient, and obtain an additional user utterance from a user for the purpose of obtaining an insufficient parameter.

In step 1518, the state receiver 710 may notify the server 60 that the parameter is insufficient. FIG. 15 illustrates that the state receiver 710 transmits a notification to the server 60. However, embodiments may not be limited thereto. For example, the notification may be transmitted to the server 60 by another module included in the electronic device 600. If the notification is received, the server 60 may transmit a message for notifying a user that the parameter is insufficient, to the electronic device 600. The electronic device 600 may output a notification message for the purpose of notifying the user that the parameter is insufficient, may receive the additional utterance or input, from the user, and may transmit the received additional utterance or input to the server 60, which may change the rule based on the additional utterance or input.

In step 1520, the server 60 may transmit the changed rule to the execution manager 620. For example, the changed rule may include the changed state including a parameter corresponding to the additional user utterance.

In step 1522, the execution manager 620 may transmit the changed state. In step 1524, the dispatcher 650 may select the task executor 700. In step 1526, the dispatcher 650 may transmit the changed state to the state receiver 710. In step 1528, the state receiver 710 may make a request for the detection of a screen to the screen detector 720. In step 1530, the screen detector 720 may detect a screen displayed in the electronic device 600. In step 1532, the screen detector 720 may transmit the detection result to the state receiver 710. In step 1534, the state receiver 710 may request the input injector 730 to inject an input. In step 1536, the input injector 730 may transmit an action corresponding to the changed state to the accessibility service module 671. In step 1538, the accessibility service module 671 may inject the action into the second group application 680. In step 1540, the accessibility service module 671 may update the screen. In step 1542, the accessibility service module 671 may transmit an event to the result monitor 740. In step 1544, the result monitor 740 may detect the screen of the electronic device 600. In step 1546, the result monitor 740 may return the execution result of the state to the execution manager 620. If the execution of all the states is completed, in step 1548, the execution manager 620 may return the execution result of the rule to the server 60.

When the parameter is insufficient, the electronic device 600 may obtain an additional touch input from a user. If the execution of a state is completed by an additional touch input, the electronic device 600 may perform steps 1540 to 1548. In this case, steps 1518 to 1538 may be omitted.

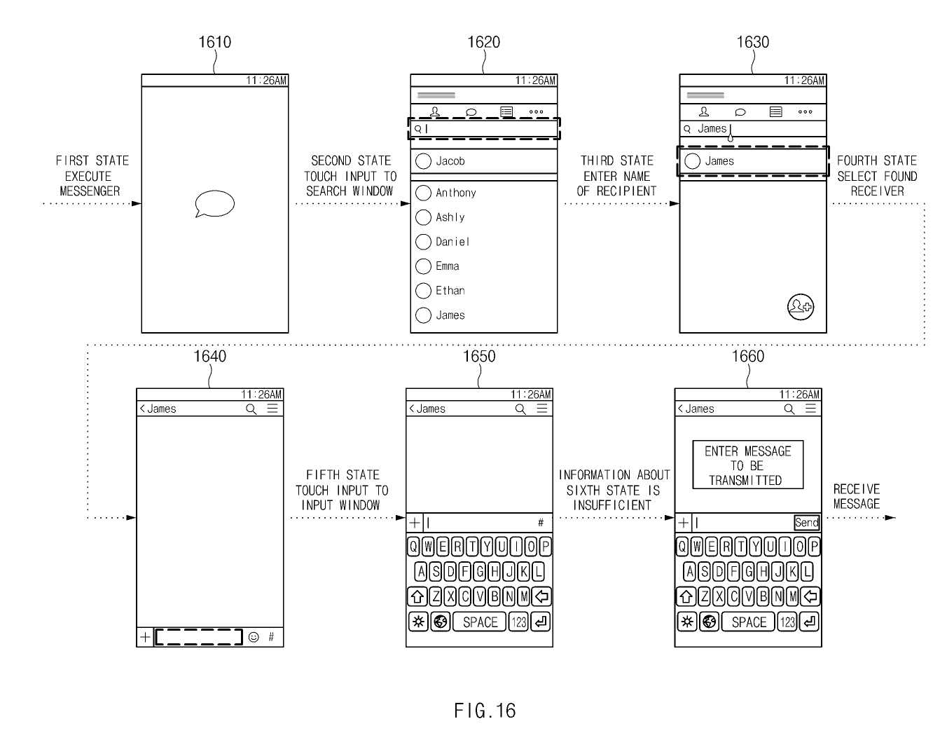

FIG. 16 illustrates a screen output by an electronic device, according to an embodiment.

Referring to FIG. 16, an electronic device may receive a rule from a server, which may receive data associated with a user utterance saying that “send a message by using a messenger to James”. The server may select or generate the rule corresponding to the user utterance, and may transmit the rule to the electronic device which may sequentially perform the sequence of states included in the rule. The sequence of states may include seven states, i.e., executing a messenger, a touch input to a search window, entering the name of a recipient, selecting the found receiver, a touch input to an input window, entering a message, and a touch input to a send button.

The electronic device may perform a first state and may output a first screen 1610. If the execution of the first state is completed, the electronic device may perform a second state and may output a second screen 1620. If the execution of the second state is completed, the electronic device may perform a third state and may output a third screen 1630. If the execution of the third state is completed, the electronic device may perform a fourth state and may output a fourth screen 1640. If the execution of the fourth state is completed, the electronic device may perform a fifth state and may output a fifth screen 1650.

If the execution of the fifth state is completed, the electronic device may perform the sixth state. An operation corresponding to the sixth state may be an input of a message. However, the user utterance corresponding to a rule may not include information about the content of a message. In this case, a parameter for performing the sixth state may be insufficient. When information about the sixth state is insufficient, the electronic device may interrupt the execution of a state. The electronic device may display a sixth screen 1660 including a popup message for providing a notification that the parameter is insufficient.

According to an embodiment, the electronic device may obtain an additional user utterance from a user for the purpose of obtaining insufficient information. The electronic device may transmit data associated with the additional user utterance to a server, may receive a rule including the sixth state corresponding to the additional user utterance, from the server, may repeat performance of the sixth state (i.e., may enter a message) based on information included in the received sixth state, and may display the entered message in a screen.

The electronic device may obtain an additional touch input from a user for the purpose of obtaining insufficient information. The message may be entered by the additional touch input. The electronic device may display the entered message in a screen.

If the execution of the sixth state is completed, the electronic device may automatically perform the remaining states.

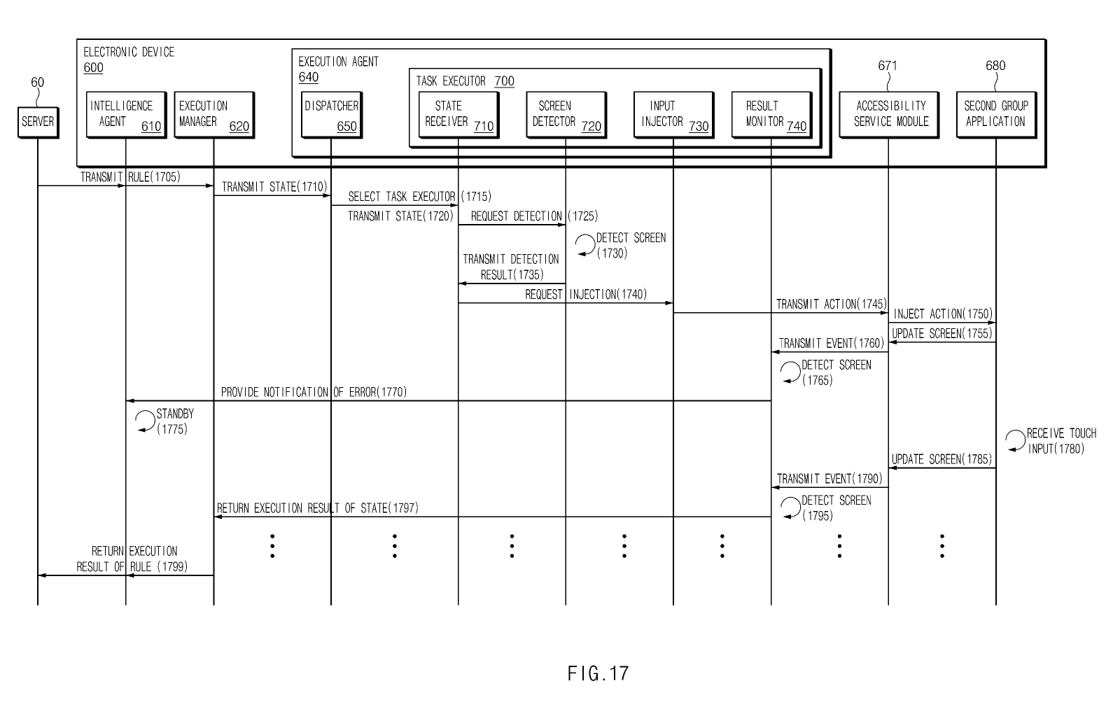

FIG. 17 illustrates an application controlling method of an electronic device, according to an embodiment.

According to an embodiment, when it is impossible to perform a state, the electronic device 600 may interrupt the execution of the state and then may obtain an additional utterance or an additional touch input from a user.

Referring to FIG. 17, in step 1705, the server 60 may transmit a rule to the intelligence agent 610, which may transmit the rule to the execution manager 620. In step 1710, the execution manager 620 may transmit the state to the dispatcher 650 of the execution agent 640. In step 1715, the dispatcher 650 may select the task executor 700. In step 1720, the dispatcher 650 may transmit the state to the state receiver 710 of the task executor 700. In step 1725, the state receiver 710 may make a request for the detection of a screen to the screen detector 720. In step 1730, the screen detector 720 may detect a screen displayed in the electronic device 600. In step 1735, the screen detector 720 may transmit the detection result to the state receiver 710. In step 1740, the state receiver 710 may request the input injector 730 to inject an input. In step 1745, the input injector 730 may transmit an action corresponding to the changed state to the accessibility service module 671. In step 1750, the accessibility service module 671 may inject the action into the second group application 680. In step 1755, the accessibility service module 671 may update the screen. In step 1760, the accessibility service module 671 may transmit an event to the result monitor 740.

In step 1765, the result monitor 740 may detect the screen of the electronic device 600. The result monitor 740 may determine whether the state is completed, by comparing information about an object included in the current screen with information about the state. When the state is not completed, the result monitor 740 may determine that an error occurs.

In step 1770, the result monitor 740 may notify the intelligence agent 610 that an error occurs. For example, when the state is not completed, the result monitor 740 may notify the intelligence agent 610 that an error occurs. The intelligence agent 610 may recognize that an error occurs.

In step 1775, when an error occurs, the intelligence agent 610 may interrupt the execution of the state, and may output a notification for providing a notification that an error occurs. In step 1780, the second group application 680 may receive a touch input from an electronic device. For example, the second group application 680 may receive an additional touch input to resolve the error.

The electronic device 600 may receive an additional utterance to resolve the error, from a user, and may perform an operation of resolving the error, based on the additional utterance.

If the state is performed by the additional touch input or the additional user utterance, in step 1785, the accessibility service module 671 may update a screen. In step 1790, the accessibility service module 671 may transmit an event to the result monitor 740. In step 1795, the result monitor 740 may detect the screen of the electronic device 600. In step 1797, the result monitor 740 may return the execution result of the state to the execution manager 620. If the execution of all the states is completed, in step 1799, the execution manager 620 may return the execution result of the rule to the intelligence agent 610, which may return the execution result of the rule to the server 60.

In FIGS. 10, 11, 12, 13, 15, and 17, a part of an operation performed by the electronic device 600 and/or a part of the program module included in the electronic device 600 may be omitted, and at least part of an operation illustrated as being performed by a specific program module of the electronic device 600 may be performed by another program module.

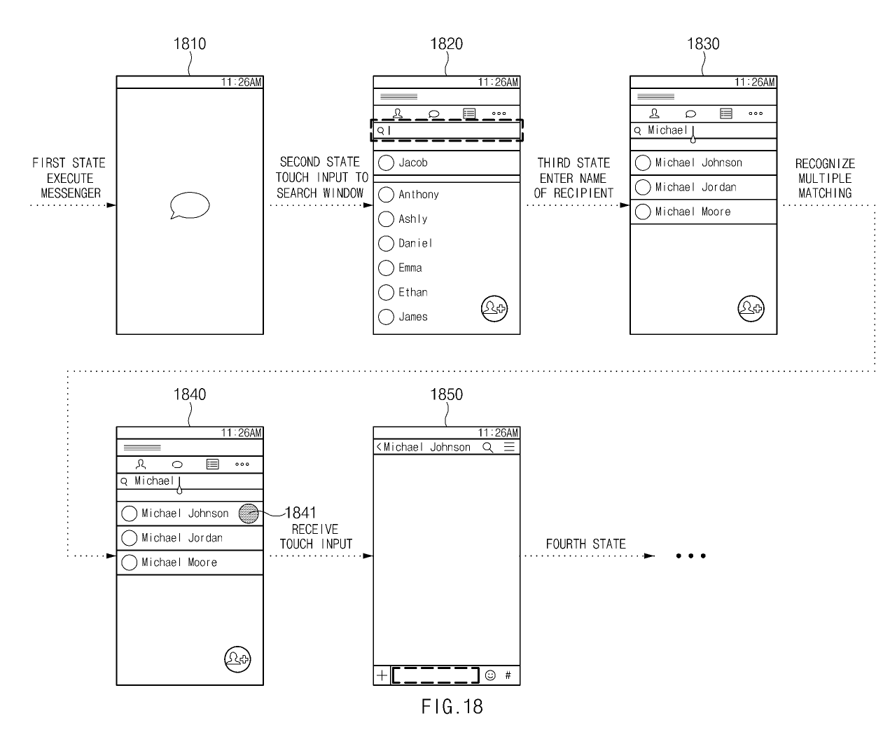

FIG. 18 illustrates a screen output by an electronic device, according to an embodiment.

Referring to FIG. 18, an electronic device may receive a rule from a server, which may receive data associated with a user utterance saying that “send a message saying that “on my way”, to Michael by using a messenger”, select or generate the rule corresponding to the user utterance, and transmit the rule to the electronic device which sequentially performs the sequence of states included in the rule. The sequence of states may include seven states, i.e., executing a messenger, a touch input to a search window, entering the name of a recipient, selecting the found receiver, a touch input to an input window, entering a message, and a touch input to a send button.

The electronic device may perform a first state and may output a first screen 1610. If the execution of the first state is completed, the electronic device may perform a second state and may output a second screen 1620. If the execution of the second state is completed, the electronic device may perform a third state and may output a third screen 1630.

When the electronic device enters Michael as a search word, as illustrated in third screen 1630, a plurality of recipients matched to the search word may be found. The electronic device may recognize multiple matching occurs, and may determine that a third state is not completed. The electronic device may interrupt the execution of the state.

The electronic device may receive a touch input to resolve the multiple matching. For example, in a fourth screen 1840, the electronic device may receive a touch input to a point 1841 corresponding to Michael Johnson, from a user. The electronic device may open a chat room with Michael Johnson and may output a fifth screen 1850, in response to the touch input to the point 1841.

The electronic device may receive a user utterance to resolve the multiple matching. For example, the electronic device may obtain a user utterance including “Michael Johnson” from the user, may open a chat room with Michael Johnson, and may output the fifth screen 1850, in response to the user utterance.

If the fifth screen 1850 is output, the electronic device may determine whether the execution of the third state is completed, by analyzing the fifth screen 1850. If it is determined that the execution of the third state is completed, the electronic device may sequentially perform states subsequent to the third state.

The term “module” used herein may include a unit, which is implemented with hardware, software, or firmware, and may be interchangeably used with the terms “logic”, “logical block”, “component”, or “circuit”. The “module” may be a minimum unit of an integrated component or a part thereof or may be a minimum unit for performing one or more functions or a part thereof, may be implemented mechanically or electronically, and may include an application-specific IC (ASIC) chip, a field-programmable gate array (FPGA), and a programmable-logic device for performing some operations, which are known or will be developed. According to embodiments, at least a part of an apparatus, such as modules or functions thereof, or a method may be implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media, such as a magnetic tape, an optical media, such as a compact disc read only memory (CD-ROM) and a digital versatile disc (DVD, a magneto-optical media, such as a floptical disk, and an embedded memory. The instruction may include codes created by a compiler or codes that are capable of being executed by a computer by using an interpreter. According to embodiments, a module or a program module may include at least one of the above elements, or a part of the above elements may be omitted, or other elements may be further included.

According to embodiments, operations executed by modules, program modules, or other elements may be executed by a successive method, a parallel method, a repeated method, or a heuristic method, or at least one part of operations may be executed in different sequences or omitted. Alternatively, other operations may be added.

While the present disclosure has been shown and described with reference to embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a housing;
a touch screen display placed inside the housing and exposed to outside the housing through a first portion of the housing;
a microphone placed inside the housing and exposed to the outside of the housing through a second portion of the housing;
at least one speaker placed inside the housing and exposed to the outside of the housing through a third portion of the housing;
a wireless communication circuit placed inside the housing;
a processor placed inside the housing and electrically connected to the touch screen display, the microphone, the speaker, and the wireless communication circuit; and
a memory placed inside the housing and electrically connected to the processor,
wherein the memory is configured to:
store a first group of application programs including a first plurality of function calls; and
store a second group of application programs downloadable from an application providing platform residing on a first external server,
wherein the memory further stores an accessibility framework, which includes a second plurality of function calls and which is a part of an operating system of the electronic device, and
wherein the memory stores instructions that, when executed, cause the processor to:
receive a user request including a request for performing a task using at least one of the first group of application programs and the second group of application programs, through at least one of the touch screen display and the microphone;
transmit data associated with the user request to a second external server through the wireless communication circuit;
receive a response including first information about a sequence of states for performing the task, and second information about at least one application to be used in association with at least one of the states, from the second external server through the wireless communication circuit;
determine whether the at least one application belongs to the first group of application programs or the second group of application programs;
if the at least one application belongs to the first group of application programs, identify one of the first plurality of function calls and perform an operation associated with the at least one state using the identified one of the first plurality of function calls; and
if the at least one application belongs to the second group of application programs, identify one of the second plurality of function calls and perform the operation associated with the at least one state using the identified one of the second plurality of function calls.

2. The electronic device of claim 1,
wherein the first group of application programs includes one or more of a gallery application, a phone application, a web browser application, a short message service application, a contact application, and an alarm application,
wherein the second group of application programs includes one or more application programs of an instant message application, a social network service application, and a content providing application, and
wherein the one or more application programs are downloadable from the application providing platform.

3. The electronic device of claim 1, wherein the memory is further configured to
store a list of the second group of application programs, and
wherein the instructions further cause the processor to update the list,
if one or more of the second group of application programs are installed, updated, or deleted.

4. The electronic device of claim 1, wherein the memory stores a list of the first group of application programs.

5. The electronic device of claim 1, wherein the instructions, when executed, further cause the processor to:
perform the operation associated with the at least one state, based on a screen displayed in the touch screen display, if the at least one application belongs to the second group of application programs.

6. An electronic device comprising:
a housing;
a touch screen display placed inside the housing and exposed to outside of the housing through a first portion of the housing;
a microphone placed inside the housing and exposed to the outside of the housing through a second portion of the housing;
a wireless communication circuit placed inside the housing;
a processor placed inside the housing and electrically connected to the microphone, the touch screen display, and the wireless communication circuit; and
a memory electrically connected to the processor and configured to store one or more applications,
wherein the memory stores instructions that, when executed, cause the processor to:
obtain a user utterance through the microphone;
transmit data associated with the user utterance to a server equipped with an intelligence system including a plurality of rules, through the wireless communication circuit;
receive a rule, which includes a sequence of states for performing a task corresponding to the user utterance, from among the plurality of rules from the server through the wireless communication circuit;
execute an application, which corresponds to a first state, from among the one or more applications to perform the first state of the sequence of states;
determine whether a second state subsequent to the first state is executable, based on a first screen of the application displayed in the touch screen display;
if the second state is executable, determine a virtual user input enabling an execution screen of the application to be changed from the first screen to a second screen corresponding to the second state;
display the second screen after performing the second state in the touch screen display based on the virtual user input; and
determine whether an execution of the second state is completed, based on the second screen displayed in the touch screen display.

7. The electronic device of claim 6, wherein the instructions, when executed, further cause the processor to:
determine whether the second state is executable, by comparing information about the first state with information about one or more objects included in the first screen.

8. The electronic device of claim 6, wherein the instructions, when executed, further cause the processor to:
determine whether an execution of the second state is completed, by comparing information about the second state with information about one or more objects included in the second screen.

9. The electronic device of claim 6, wherein the instructions, when executed, further cause the processor to:
obtain information about one or more objects included in the first screen, if the application is executed; and
obtain information about one or more objects included in the second screen, if the second screen is displayed in the touch screen display.

10. The electronic device of claim 9, wherein the instructions, when executed, further cause the processor to:
obtain the information about the one or more objects included in the first screen and the information about the one or more objects included in the second screen, using an Android® framework stored in the memory.

11. The electronic device of claim 6, wherein the instructions, when executed, further cause the processor to:
display the second screen in the touch screen display, by performing an operation corresponding to the virtual user input.

12. The electronic device of claim 11, wherein the instructions, when executed, further cause the processor to:
perform an operation corresponding to the virtual user input using an Android® framework stored in the memory.

13. The electronic device of claim 6, wherein the instructions, when executed, further cause the processor to:
determine the virtual user input including information about an object and information about an input manner corresponding to the object, if the second state is executable; and
display the second screen in the touch screen display by applying the virtual user input to the object.

14. The electronic device of claim 6, wherein the memory stores a plurality of applications and a plurality of plug-ins respectively corresponding to the plurality of applications, and
wherein the instructions, when executed, further cause the processor to:
select a plug-in, which corresponds to the application, from among the plurality of plug-ins; and
perform the sequence of states using the selected plug-in.

15. The electronic device of claim 14, wherein the instructions, when executed, further cause the processor to:
execute the application using the selected plug-in;
determine the virtual user input using the selected plug-in; and
display the second screen in the touch screen display using the selected plug-in.

16. The electronic device of claim 6, wherein the instructions, when executed, further cause the processor to:
obtain, if information associated with the second state is insufficient, an additional user utterance associated with the second state through the microphone;
transmit data associated with the additional user utterance to the server through the wireless communication circuit;
receive the information associated with the second state from the server through the wireless communication circuit; and
determine, if the second state is executable, the virtual user input enabling an execution screen of the application to be changed from the first screen to the second screen, based on the information associated with the second state.

17. The electronic device of claim 6, wherein the instructions, when executed, further cause the processor to:
receive, if information associated with the second state is insufficient, a touch input associated with the second state through the touch screen display;
display a screen after performing an operation corresponding to the touch input, in the touch screen display; and
determine whether an execution of the second state is completed, based on the screen after performing the operation corresponding to the touch input.

18. The electronic device of claim 6, wherein the instructions, when executed, further cause the processor to:
transmit, if an execution of the sequence of states is completed, the execution result to the server through the wireless communication circuit.

19. The electronic device of claim 6, wherein the instructions, when executed, further cause the processor to:
perform the sequence of states by calling at least part of the functions, if functions associated with the application are predefined.

20. An application controlling method of an electronic device, the method comprising:
obtaining a user utterance;
transmitting data associated with the user utterance to a server equipped with an intelligence system including a plurality of rules;
receiving a rule, which includes a sequence of states for performing a task corresponding to the user utterance, from among the plurality of rules from the server;
executing an application corresponding to a first state to perform the first state of the sequence of states;
determining whether a second state subsequent to the first state is executable, based on a first screen of the application;
determining, if the second state is executable, a virtual user input enabling an execution screen of the application to be changed from the first screen to a second screen corresponding to the second state;
displaying the second screen after performing the second state based on the virtual user input; and
determining whether an execution of the second state is completed, based on the second screen.
